(19) United States
(12) Patent Application Publication
(10) Pub. No.: US 2015/0358656 A1
(43) Pub. Date: Dec. 10, 2015

(54) INFORMATION PROVIDING SYSTEM AND INFORMATION PROVIDING METHOD

(71) Applicant: Panasonic Intellectual Property Management Co., Ltd., Osaka (JP)

(72) Inventors: Kouichi MATSUMURA, Osaka (JP); Sako KONDO, Osaka (JP); Masafumi SHIMOTASHIRO, Osaka (JP)

(21) Appl. No.: 14/733,888

(22) Filed: Jun. 8, 2015

(30) Foreign Application Priority Data
Jun. 10, 2014 (JP) 2014-119224
Apr. 13, 2015 (JP) 2015-081380

(51) Int. Cl. H04N 21/25; H04N 21/41; H04N 21/61; H04N 21/4782; H04N 21/81; H04N 21/258; H04N 21/426

(52) U.S. Cl. CPC H04N 21/251; H04N 21/25808; H04N 21/4126; H04N 21/42684; H04N 21/25866; H04N 21/4782; H04N 21/812; H04N 21/6125

(57) ABSTRACT

An information providing system includes a television receiver, a user terminal, and a connection state management server each connectable to a network. The user terminal can execute a program for connecting with the television receiver. The connection state management server obtains connection state information including an identifier of the television receiver and an identifier of the user terminal, through a network from one of the television receiver and the user terminal connected to each other. Further, the connection state management server scores a degree of relevance representing a level of relevance between the television receiver and the user terminal connected to each other, based on the obtained connection state information. Furthermore, the connection state management server provides the scored degree of relevance to a request source in response to a request from an outside.

### BACKGROUND

1. Field of the Disclosure

The present disclosure relates to an information providing system and an information providing method which provide information related to a user terminal and a television receiver connected to each other, to an outside.

2. Background Art

Unexamined Japanese Patent Publication No. 2010-109603 (Patent Literature 1) discloses a television system (hereinafter, television will be abbreviated as “TV”) connectable to the Internet. This TV system includes a TV receiver connectable to the Internet and a user terminal connectable to the Internet and for using a browser, and the TV receiver and the user terminal are associated with each other through a server connectable to the Internet.

Further, there is known a method for distributing advertisement information, in which an owner (hereinafter, also referred to as a “user”) of the user terminal is highly interested, to the user terminal connectable to the Internet. According to this method, advertisement information to be distributed to the user terminal is selected based on a browsing history of webpages stored in the user terminal.

### SUMMARY

The present disclosure provides an information providing system and an information providing method which can score a degree of relevance between a user terminal and a TV receiver connected to each other, and can provide the degree of relevance to an outside.

An information providing system according to the present disclosure includes a television receiver connectable to a network, a user terminal connectable to the network, and a connection state management server connectable to the network. The user terminal can execute a program for connecting with the television receiver. The connection state management server obtains connection state information including an identifier of the television receiver and an identifier of the user terminal, through a network from one of the television receiver and the user terminal connected to each other. Further, the connection state management server scores a degree of relevance representing a level of relevance between the television receiver and the user terminal connected to each other, based on the obtained connection state information. Furthermore, the connection state management server provides the scored degree of relevance to a request source in response to a request from an outside.

An information providing method according to the present disclosure is an information providing method for an information providing system which includes a television receiver connectable to a network, a user terminal configured to execute a program for connecting with the television receiver, and connectable to the network, and a connection state management server connectable to the network. This information providing method includes: at the connection state management server, obtaining connection state information including an identifier of the television receiver and an identifier of the user terminal from one of the television receiver and the user terminal connected to each other; at the connection state management server, scoring a degree of relevance representing a level of relevance between the television receiver and the user terminal connected to each other, based on the connection state information; and at the connection state management server, providing the scored degree of relevance in response to a request from an outside.

The information providing system according to the present disclosure is effective to score the degree of relevance between the user terminal and the TV receiver connected to each other.

### BRIEF DESCRIPTION OF DRAWINGS

FIG. 1 is a diagram schematically illustrating a configuration example of an advertisement distribution system including an information providing system according to the first exemplary embodiment;

FIG. 2 is a block diagram illustrating a configuration example of a user terminal according to the first exemplary embodiment;

FIG. 3 is a block diagram illustrating a configuration example of a TV receiver according to the first exemplary embodiment;

FIG. 4 is a block diagram illustrating a configuration example of a connection state management server according to the first exemplary embodiment;

FIG. 5 is a diagram illustrating an example of a connection state management table held in the connection state management server according to the first exemplary embodiment;

FIG. 6 is a diagram illustrating an example of a relevance degree management table held in the connection state management server according to the first exemplary embodiment;

FIG. 7 is a diagram illustrating an example of a relevance degree reference table held in the connection state management server according to the first exemplary embodiment;

FIG. 8 is a sequence diagram illustrating an example of an operation of transmitting connection state information from the user terminal to the connection state management server according to the first exemplary embodiment;

FIG. 9 is a sequence diagram illustrating an example of an operation of the advertisement distribution system according to the first exemplary embodiment;

FIG. 10 is a sequence diagram illustrating an example of an operation of transmitting connection state information from the TV receiver to the connection state management server according to the first exemplary embodiment;

FIG. 11 is a sequence diagram illustrating an example of an operation of transmitting connection state information from a user terminal to a connection state management server according to a second exemplary embodiment;

FIG. 12 is a sequence diagram illustrating an example of an operation of transmitting connection state information from a TV receiver to the connection state management server according to the second exemplary embodiment;

FIG. 13 is a block diagram illustrating a configuration example of a user terminal according to a third exemplary embodiment;

FIG. 14 is a block diagram illustrating a configuration example of a TV receiver according to the third exemplary embodiment;

FIG. 15 is a diagram illustrating an example of a connection state management table held in the connection state management server according to the third exemplary embodiment; and

FIG. 16 is a diagram illustrating an example of a relevance degree reference table held in the connection state management server according to the third exemplary embodiment.

### DETAILED DESCRIPTION

Hereinafter, exemplary embodiments will be described in detail with reference to the accompanying drawings as appropriate. However, unnecessarily detailed description may occasionally be omitted. For example, detailed description of well-known matters and redundant description of substantially the same configurations may occasionally be omitted. The omission of these items is to avoid the following description from becoming unnecessarily redundant, and to ease understanding of those skilled in the art.

It should be noted that the following description and the accompanying drawings are provided to allow any person skilled in the art to fully understand the present disclosure, and that it is not intended to limit the subject matter described in the claims by the following description and the accompanying drawings.

### First Exemplary Embodiment

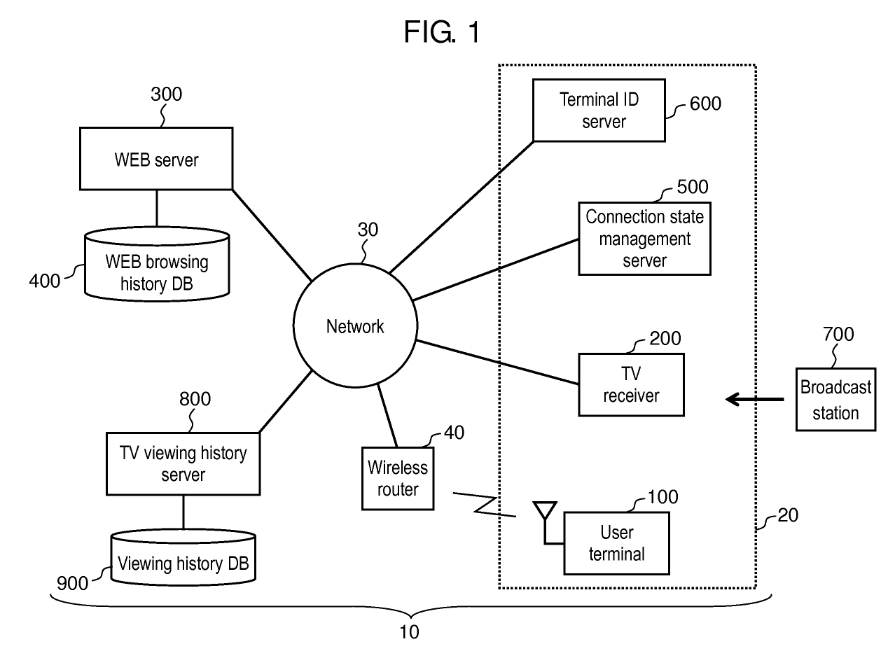

A first exemplary embodiment will be described below with reference to FIGS. 1 to 10.

[1-1. Configuration and Operation]

FIG. 1 is a diagram schematically illustrating a configuration example of advertisement distribution system 10 including information providing system 20 according to the first exemplary embodiment.

As illustrated in FIG. 1, advertisement distribution system 10 includes information providing system 20, web server 300, web browsing history DB (DataBase) 400, TV viewing history server 800, and viewing history DB 900.

Information providing system 20 includes user terminal 100, TV receiver 200, terminal ID (IDentification) server 600 and connection state management server 500.

In addition, FIG. 1 illustrates an example where one user terminal 100 and one TV receiver 200 are connected to network 30. However, the first exemplary embodiment is by no means limited to this configuration. Pluralities of user terminals 100 and TV receivers 200 may be connected to network 30.

User terminal 100 is an information terminal which a user (not illustrated) possesses. User terminal 100 is configured to connect to network 30 through wireless router 40, and can transmit and receive data to and from each server connected to network 30 through wireless router 40 and network 30. Further, user terminal 100 is configured to activate a browser. The browser is a program (application software which is abbreviated as an “application” hereinafter) for displaying webpages transmitted from web server 300 on network 30. Further, user terminal 100 is configured to execute a program (application) for connecting with TV receiver 200 connected to network 30. User terminal 100 on which this application is running transmits a connection request to TV receiver 200 through wireless router 40 and network 30, and can communicate with TV receiver 200 when this connection request is accepted. User terminal 100 will be described in detail later.

TV receiver 200 is configured to connect to network 30, and can transmit and receive data to and from each server connected to network 30, through network 30. Further, TV receiver 200 can accept a connection request transmitted from user terminal 100, and communicate with user terminal 100 through network 30. Furthermore, TV receiver 200 can receive broadcast waves (data broadcast waves) transmitted from broadcast station 700. TV receiver 200 will be described in detail later.

Web server 300 is a server computer connected to network 30, and is configured to transmit webpages to user terminal 100 through network 30. For example, Web server 300 may be an advertisement distribution server which distributes advertisement information to user terminal 100. A webpage transmitted from web server 300 is displayed on a browser running on user terminal 100.

Web browsing history DB 400 is a database stored in a storage device (e.g., a hard disk drive) connected to web server 300. Web browsing history DB 400 may be stored in a storage device built in web server 300. Web browsing history DB 400 stores a browsing history of webpages in user terminal 100 connected to web server 300, in association with information for specifying user terminal 100 (e.g., a terminal ID of user terminal 100).

Connection state management server 500 is a server computer connected to network 30, and is configured to manage a connection state between user terminal 100 and TV receiver 200. Connection state management server 500 will be described in detail later.

Terminal ID server 600 is a server computer connected to network 30, and is configured to manage terminal IDs. Terminal ID server 600 generates as a terminal ID a unique identifier for specifying user terminal 100, and assigns the terminal ID to each user terminal 100. In addition, a configuration of terminal ID server 600 is substantially the same as those of general server computers, and therefore will not be described in detail.

Broadcast station 700 distributes broadcast waves including data broadcast.

TV viewing history server 800 is a server computer connected to network 30. TV viewing history server 800 manages a viewing history of TV programs (hereinafter, referred to as a “program viewing history” or simply as a “viewing history”) in TV receiver 200 by using viewing history DB 900. TV receiver 200 transmits, to TV viewing history server 800, information, such as channel information, program information, and time information, required to generate a program viewing history, and information for specifying TV receiver 200 (e.g., receiver ID) when an event such as supply of power or a change of a channel occurs. In addition, a receiver ID is an example of an identifier of TV receiver 200. TV viewing history server 800 receives the relevant information, generates a viewing history of TV receiver 200, and accumulates the generated viewing history in viewing history DB 900. Thus, TV viewing history server 800 manages viewing histories of TV receiver 200.

Viewing history DB 900 is a database stored in a storage device (e.g., a hard disk drive) connected to TV viewing history server 800. Viewing history DB 900 may be stored in a storage device built in TV viewing history server 800.

[1-1-1. Configuration of User Terminal]

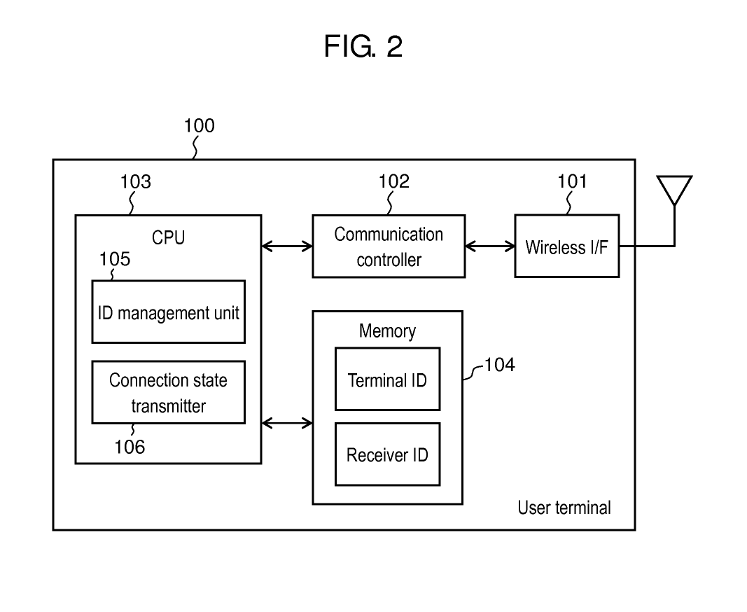

FIG. 2 is a block diagram illustrating a configuration example of user terminal 100 according to the first exemplary embodiment.

User terminal 100 is, for example, a smartphone. It should be noted that only blocks related to the present exemplary embodiment will be described below with reference to FIG. 2, and functions of a general smartphone (e.g., a microphone, a speaker, and an input unit) will not be illustrated and described.

It should be noted that user terminal 100 is by no means limited to smartphones, and only needs to be a device which can connect to network 30 and activate a browser and a program for connecting with TV receiver 200.

User terminal 100 includes wireless I/F (InterFace) 101, communication controller 102, CPU (Central Processing Unit) 103, and memory 104.

Wireless I/F 101 is configured to wirelessly connect to wireless router 40, and transmit and receive data to and from network 30 through wireless router 40. Thus, user terminal 100 can communicate with other devices connected to network 30, through network 30. In addition, wireless I/F 101 may be configured to connect with network 30 through a cable.

Communication controller 102 performs predetermined processing on data and a request received by wireless I/F 101 to convert the data and the request into data of a format that CPU 103 can process, and outputs the converted data to CPU 103. Further, communication controller 102 performs predetermined processing on data and a request output from CPU 103 to convert the data and the request into data of a format which can be output to an outside, and outputs the converted data to the outside through wireless I/F 101. These items of data and requests will be described later.

CPU 103 includes ID management unit 105 and connection state transmitter 106. CPU 103 controls each unit of user terminal 100. Control targets of CPU 103 may include blocks which are not illustrated.

Further, CPU 103 can execute the browser and an application for connecting with TV receiver 200. When, for example, CPU 103 executes the application for connecting with TV receiver 200, CPU 103 transmits information for specifying user terminal 100 (e.g., IP (Internet Protocol) address) and a connection request to TV receiver 200 through communication controller 102 and wireless I/F 101. When receiving a reply that connection is permitted from TV receiver 200, CPU 103 starts communicating with TV receiver 200 through communication controller 102 and wireless I/F 101.

ID management unit 105 manages a terminal ID of user terminal 100 and a receiver ID of TV receiver 200. The terminal ID is an example of an identifier of user terminal 100. The terminal ID and the receiver ID will be described later. ID management unit 105 obtains the terminal ID of user terminal 100 from terminal ID server 600, and stores the obtained terminal ID in memory 104. ID management unit 105 makes a request to TV receiver 200 to transmit the receiver ID, receives the receiver ID transmitted from TV receiver 200 in response to this request, and stores the receiver ID in memory 104. Further, when receiving a transmission request of the terminal ID transmitted from TV receiver 200, ID management unit 105 transmits the terminal ID of user terminal 100 to TV receiver 200.

Connection state transmitter 106 transmits a connection state of user terminal 100 and TV receiver 200 to connection state management server 500. Connection state transmitter 106 transmits a pair of the terminal ID and the receiver ID as connection state information to connection state management server 500 at a predetermined interval (for example, every one minute) when connection between user terminal 100 and TV receiver 200 is established.

In addition, it is assumed that information related to this “predetermined interval” is shared in advance between devices which make up information providing system 20.

In addition, connection state transmitter 106 does not transmit connection state information when user terminal 100 and TV receiver 200 are not connected. However, the present exemplary embodiment is by no means limited to this configuration. When, for example, user terminal 100 and TV receiver 200 are not connected, connection state transmitter 106 may transmit information indicating that user terminal 100 and TV receiver 200 are not connected, to connection state management server 500.

Memory 104 is, for example, a semiconductor memory element and is a memory device which is configured to allow data to be freely written and read. Memory 104 stores the terminal ID of user terminal 100 and the receiver ID received from TV receiver 200. Memory 104 may store the browser and the application for connecting with TV receiver 200. Further, memory 104 may be, for example, a hard disk drive.

The terminal ID is an identifier which makes it possible to uniquely specify user terminal 100, and is managed by terminal ID server 600. However, for example, an IP address of user terminal 100 or a Cookie of the browser implemented in user terminal 100 may be used for the terminal ID.

The receiver ID is an identifier which is held in TV receiver 200 and is unique to TV receiver 200. For example, an ID of a B-CAS (Conditional Access System) card or a unique ID assigned by a TV receiver manufacturer may be used for the receiver ID. Further, other identifiers may be used for the receiver ID.

[1-1-2. Configuration of TV Receiver]

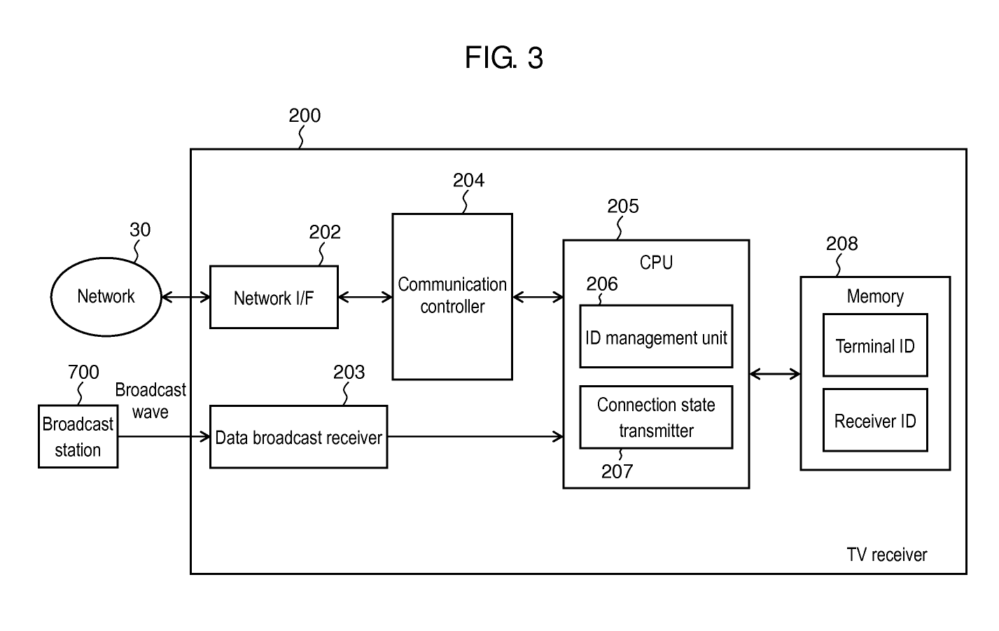

FIG. 3 is a block diagram illustrating a configuration example of TV receiver 200 according to the first exemplary embodiment. It should be noted that only blocks related to the present exemplary embodiment will be described below with reference to FIG. 3, and functions of a general TV receiver (e.g., a video signal processor, a display, an audio signal processor, a speaker and the like) will not be illustrated and described.

TV receiver 200 includes network I/F 202, data broadcast receiver 203, communication controller 204, CPU 205, and memory 208.

Network I/F 202 is configured to connect to network 30, and transmit and receive data to and from network 30. Thus, TV receiver 200 can communicate with other devices connected to network 30, through network 30. In addition, for example, network I/F 202 may be configured to wirelessly connect with wireless router 40.

Data broadcast receiver 203 receives data broadcast waves transmitted from broadcast station 700, performs predetermined processing on a received signal to convert the signal into data of a format that CPU 205 can process, and outputs the converted data to CPU 205.

Communication controller 204 performs predetermined processing on data and a request received by network I/F 202 to convert the data and the request into data of a format that CPU 205 can process, and outputs the converted data to CPU 205. Further, communication controller 204 performs predetermined processing on data and a request output from CPU 205 to convert the data and the request into data of a format which can be output to an outside, and outputs the converted data to the outside through network I/F 202. These items of data and requests will be described later.

CPU 205 includes ID management unit 206 and connection state transmitter 207. CPU 205 controls each unit of TV receiver 200. Control targets of CPU 205 may include blocks which are not illustrated. For example, CPU 205 may control each block to display video images of data broadcast received by data broadcast receiver 203, on a display (not illustrated).

Further, CPU 205 communicates with user terminal 100 through communication controller 204 and network I/F 202. When the information for specifying user terminal 100 and the connection request are transmitted from user terminal 100, CPU 205 receives the information and the connection request, determines whether or not to permit connection, and returns a determination result to user terminal 100. When the determination result is to permit connection, CPU 205 controls each block to start communication with user terminal 100.

ID management unit 206 manages a terminal ID of user terminal 100 and a receiver ID of TV receiver 200. ID management unit 206 makes a request to user terminal 100 to transmit the terminal ID, receives the terminal ID transmitted from user terminal 100 in response to this request, and stores the terminal ID in memory 208. Further, when receiving a transmission request of the receiver ID transmitted from user terminal 100, ID management unit 206 transmits the receiver ID of TV receiver 200 to user terminal 100.

Connection state transmitter 207 transmits a connection state of user terminal 100 and TV receiver 200 to connection state management server 500. Connection state transmitter 207 transmits a pair of the terminal ID and the receiver ID as connection state information to connection state management server 500 at a predetermined interval (for example, every one minute) when connection between user terminal 100 and TV receiver 200 is established.

In addition, it is assumed that information related to this “predetermined interval” is shared in advance between devices which make up information providing system 20.

In addition, connection state transmitter 207 does not transmit connection state information when user terminal 100 and TV receiver 200 are not connected. However, the present exemplary embodiment is by no means limited to this configuration. When, for example, user terminal 100 and TV receiver 200 are not connected, connection state transmitter 207 may transmit information indicating that user terminal 100 and TV receiver 200 are not connected, to connection state management server 500.

Memory 208 is, for example, a semiconductor memory element and is a memory device which is configured to allow data to be freely written and read. Memory 208 stores the receiver ID of TV receiver 200. Memory 208 may store a device ID received from user terminal 100 connected to TV receiver 200. Further, memory 208 may be, for example, a hard disk drive.

[1-1-3. Configuration of Connection State Management Server]

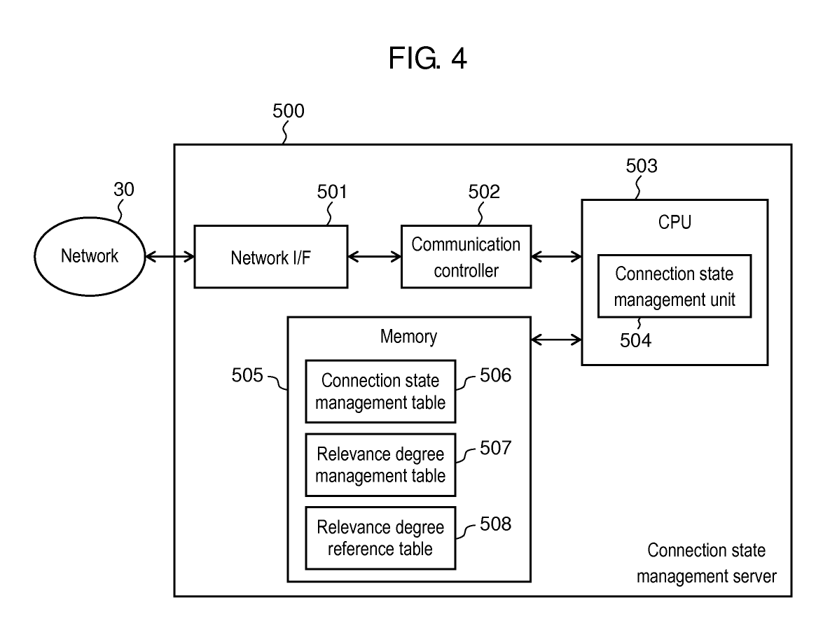

FIG. 4 is a block diagram illustrating a configuration example of connection state management server 500 according to the first exemplary embodiment. It should be noted that only blocks related to the present exemplary embodiment will be described below with reference to FIG. 4, and functions of a general server will not be illustrated and described.

Connection state management server 500 includes network I/F 501, communication controller 502, CPU 503, and memory 505.

Connection state management server 500 scores a degree of relevance representing a level of relevance between TV receiver 200 and user terminal 100 connected to each other, based on the connection state information, and provides the scored degree of relevance in response to a request from the outside. Hence, connection state management server 500 includes one or more rules for scoring the degree of relevance. A reference value to be compared with information obtained from the connection state information, and a relevance degree point to be added to the degree of relevance based on the comparison result are registered for each rule in advance in association with each other.

Network I/F 501 is configured to connect to network 30, and transmit and receive data to and from network 30. Thus, connection state management server 500 can communicate with other devices connected to network 30, through network 30. In addition, for example, network I/F 501 may be configured to wirelessly connect with wireless router 40.

Communication controller 502 performs predetermined processing on data and a request received by network I/F 501 to convert the data and the request into data of a format that CPU 503 can process, and outputs the converted data to CPU 503. Further, communication controller 502 performs predetermined processing on data and a request output from CPU 503 to convert the data and the request into data of a format which can be output to an outside, and outputs the converted data to the outside through network I/F 501. These items of data and requests will be described later.

CPU 503 includes connection state management unit 504. CPU 503 controls each unit of connection state management server 500. Control targets of CPU 503 may include blocks which are not illustrated.

Connection state management unit 504 receives connection state information transmitted from user terminal 100 at a predetermined interval (e.g., every one minute).

In addition, it is assumed that information related to this “predetermined interval” is shared in advance between devices which make up information providing system 20.

Further, connection state management unit 504 stores the connection state information and time information indicating a reception time of the connection state information in connection state management table 506 in association with each other. Connection state management unit 504 stores only the time information indicating a scheduled reception time in connection state management table 506 when connection state information is not received at the predetermined interval, i.e., when the connection state information is not received at the scheduled reception time.

In addition, connection state management unit 504 can calculate this scheduled reception time based on the predetermined interval (e.g., one minute) and the reception time of the connection state information.

Further, connection state management unit 504 refers to connection state management table 506, and scores the degree of relevance between user terminal 100 and TV receiver 200 connected to each other based on a predetermined reference (rule). Furthermore, connection state management unit 504 stores relevance degree information including the scored degree of relevance (the scored degree of relevance will be referred to simply as “the degree of relevance” hereinafter), in relevance degree management table 507. The relevance degree information is information in which the degree of relevance between user terminal 100 and TV receiver 200 connected to each other, and the terminal ID of user terminal 100 and the receiver ID of television receiver 200 are associated with each other. In addition, a flow of processing of scoring the degree of relevance will be described later.

Memory 505 is, for example, a hard disk drive and is a memory device which is configured to allow data to be freely written and read. Memory 505 stores connection state management table 506 used to manage a connection state of user terminal 100 and TV receiver 200, relevance degree management table 507 used to manage the degree of relevance between user terminal 100 and TV receiver 200, and relevance degree reference table 508 used to calculate the degree of relevance between user terminal 100 and TV receiver 200. Memory 505 is, for example, a semiconductor memory element.

Next, each of connection state management table 506, relevance degree management table 507 and relevance degree reference table 508 will be described.

[1-2. Configuration of Connection State Management Table]

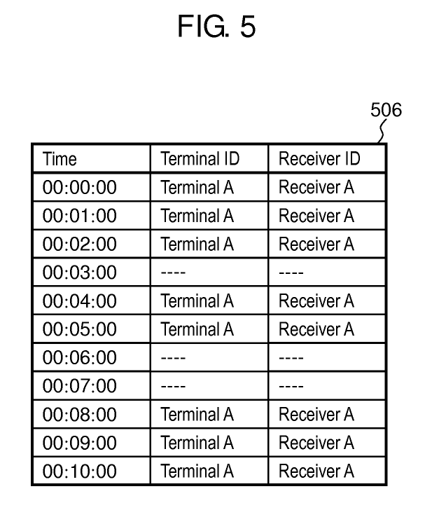

FIG. 5 is a diagram illustrating an example of connection state management table 506 held in connection state management server 500 according to the first exemplary embodiment.

As illustrated in FIG. 5, connection state management table 506 stores time information, the terminal ID, and the receiver ID in association with each other. It should be noted that FIG. 5 illustrates an example where the predetermined interval is “one minute”. However, this interval is by no means limited to one minute.

The terminal ID illustrated in FIG. 5 is a terminal ID included in the connection state information, and is information uniquely indicating user terminal 100 which holds this terminal ID. FIG. 5 illustrates, for example, the terminal ID as a “terminal A”. However, the terminal ID is by no means limited to this.

The receiver ID illustrated in FIG. 5 is a receiver ID included in connection state information, and is information uniquely indicating TV receiver 200 which holds this receiver ID. FIG. 5 illustrates, for example, the receiver ID as “receiver A”. However, the receiver ID is by no means limited to this.

The time information illustrated in FIG. 5 indicates a time at which connection state information of each of the terminal ID and the receiver ID is received, and a scheduled reception time. In addition, although not illustrated in FIG. 5, the time information may include date information and day information.

FIG. 5 illustrates a case as an example where connection state management server 500 receives connection state information every one minute from time 00:00:00 to time 00:10:59, and does not receive the connection state information at time 00:03:00, time 00:06:00 and time 00:07:00 which are scheduled reception times.

In the example illustrated in FIG. 5, connection state management server 500 determines that terminal A is connected to receiver A in a period from time 00:00:00 to time 00:02:59, a period from time 00:04:00 to time 00:05:59, and a period from time 00:08:00 to time 00:10:59. Further, connection state management server 500 determines that user terminal 100 and TV receiver 200 are not connected in a period from time 00:03:00 to time 00:03:59 and a period from time 00:06:00 to time 00:07:59.

Hence, in the example illustrated in FIG. 5, connection state management server 500 determines that durations of connection times of terminal A and receiver A are 2 minutes and 59 seconds from time 00:00:00 to time 00:02:59, 1 minute and 59 seconds from time 00:04:00 to time 00:05:59, and 2 minutes and 59 seconds from time 00:08:00 to time 00:10:59.

Further, in the example illustrated in FIG. 5, connection state management server 500 determines that the number of times that terminal A and receiver A are connected with each other is three times in a period from time 00:00:00 to time 00:10:00.

Thus, connection state management server 500 can determine a connection state of user terminal 100 and TV receiver 200 based on connection state management table 506 stored in memory 505.

[1-3. Configuration of Relevance Degree Management Table]

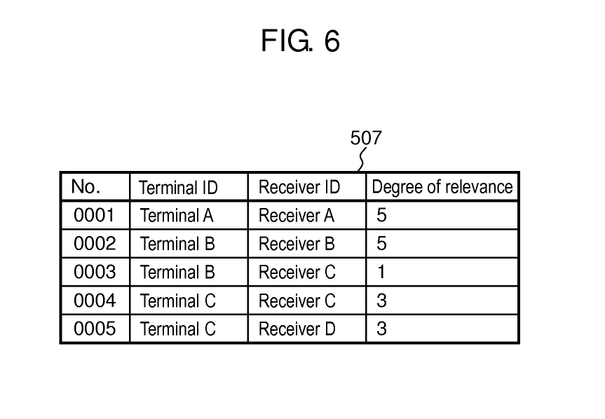

FIG. 6 is a diagram illustrating an example of relevance degree management table 507 held in connection state management server 500 according to the first exemplary embodiment. FIG. 6 illustrates an example where terminal IDs are “terminal A”, “terminal B” and “terminal C”, and receiver IDs are “receiver A”, “receiver B” and “receiver C”. The terminals ID and the receiver IDs are not limited to these.

Further, FIG. 6 illustrates a case as an example where terminal A is connected with receiver A, terminal B is connected with receiver B and receiver C, and terminal C is connected with receiver C and receiver D.

As illustrated in the example in FIG. 6, relevance degree management table 507 stores a plurality of pieces of relevance degree information in which terminal IDs and receiver IDs to which the degrees of relevance have been previously allocated, and the degrees of relevance are associated with each other.

The “degree of relevance” in the present disclosure refers to the strength of a relationship (a level of relevance) between user terminal 100 and TV receiver 200. The relationship between user terminal 100 and TV receiver 200 is stronger (relevance is higher) as a numerical value of the degree of relevance is higher, and is weaker (relevance is lower) as the numerical value of the degree of relevance is smaller.

For example, in the example illustrated in FIG. 6, relevance degree information of No. 0001 indicates that the degree of relevance between terminal A and receiver A is “5”. In the example described in the present exemplary embodiment, the degree of relevance “5” indicates that the relationship between user terminal 100 and TV receiver 200 is relatively strong. Hence, the relevance degree information of No. 0001 in FIG. 6 indicates that there is a relatively strong relationship between terminal A and receiver A. This strong relationship is produced in, for example, a situation that receiver A is a TV receiver placed at a house of an owner of terminal A. It should be noted that this situation is merely one example where there is a relatively strong relationship between user terminal 100 and TV receiver 200, and a relatively strong relationship may be produced between user terminal 100 and TV receiver 200 under other situations.

Further, in the example illustrated in FIG. 6, relevance degree information of No. 0002 indicates the degree of relevance between terminal B and receiver B, and the relevance degree information of No. 0003 indicates the degree of relevance between terminal B and receiver C. Thus, one user terminal 100 (e.g., terminal B) is connected with a plurality of TV receivers 200 (e.g., receiver B and receiver C) in some cases. Hence, connection state management server 500 stores the respective degrees of relevance, too, in such a case. In the example illustrated in FIG. 6, terminal B and receiver B have the degree of relevance “5” which represents a relatively strong relationship. Meanwhile, terminal B and receiver C have the degree of relevance “1” which represents a relatively weak relationship. This relationship is produced when, for example, receiver B is placed in a room of an owner of terminal B, and receiver C is placed in another room (e.g., a living room of a house of the owner of terminal B). It should be noted that this situation is merely one example where there are a relatively strong relationship and a relatively weak relationship between one user terminal 100 and two TV receivers 200, and the same relationship may be produced between user terminal 100 and TV receivers 200 under other situations.

Further, in the example illustrated in FIG. 6, relevance degree information of No. 0003 indicates the degree of relevance between terminal B and receiver C, and the relevance degree information of No. 0004 indicates the degree of relevance between terminal C and receiver C. Thus, one TV receiver 200 (e.g., receiver C) is connected with a plurality of user terminals 100 (e.g., terminal B and terminal C) in some cases. Hence, connection state management server 500 stores the respective degrees of relevance, too, in such a case. In the example illustrated in FIG. 6, receiver C and terminal B have the degree of relevance “1” which represents a relatively weak relationship. Meanwhile, receiver C and terminal C have the degree of relevance “3” which represents a stronger relationship than that of a combination of receiver C and terminal B. This relationship is produced under a situation that, for example, terminal C is a possession of a person living in a house in which receiver C is placed, and terminal B is a possession of a person visiting this house sometimes. It should be noted that this situation is merely one example where there are a relatively weak relationship and a slightly strong relationship between two user terminals 100 and one TV receiver 200, and the same relationship may be produced under other situations.

Thus, connection state management server 500 can grasp the degree of relevance between user terminal 100 and TV receiver 200 based on relevance degree management table 507 stored in memory 505.

It should be noted that a relationship between strength/weakness of the relationship and a numerical value of the degree of relevance is merely one example. A numerical value of the degree of relevance depends on how relevance degree reference table 508 described below is set. Hence, even when the degree of relevance is “5”, the relationship is relatively weak in some cases.

[1-4. Configuration of Relevance Degree Reference Table]

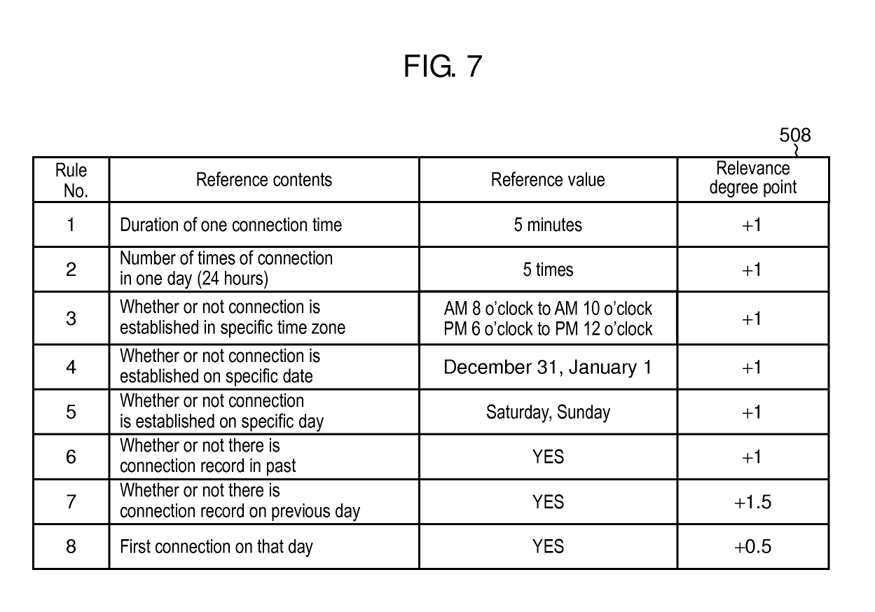

FIG. 7 is a diagram illustrating an example of relevance degree reference table 508 held in connection state management server 500 according to the first exemplary embodiment. Relevance degree reference table 508 is used when connection state management unit 504 calculates the degree of relevance between user terminal 100 and TV receiver 200.

As illustrated in FIG. 7, in relevance degree reference table 508, a plurality of rules in which reference contents, reference values, and relevance degree points are associated with each other are registered. Connection state management server 500 compares, based on each rule, information corresponding to reference contents with the reference value, and calculates the degree of relevance based on the comparison result. More specifically, connection state management server 500 adds the relevance degree point allocated to the rule, to the degree of relevance between user terminal 100 and TV receiver 200 when the information corresponding to the reference contents indicates the reference value or more or corresponds to the reference value. Connection state management server 500 does not add the relevance degree point to the degree of relevance between user terminal 100 and TV receiver 200 when the information corresponding to the reference contents indicates less than the reference value or does not correspond to the reference value.

A more specific example of the rule will be described below with reference to FIG. 7.

In the example indicated in rule No. 1 in FIG. 7, “a duration of one connection time” is set as reference contents, “5 minutes” is set as a reference value, and “+1” is set to a relevance degree point. Hence, connection state management unit 504 first refers to connection state management table 506 illustrated in FIG. 5 and calculates a duration of one connection time when calculating the degree of relevance based on rule No. 1. Further, connection state management unit 504 does not add the relevance degree point to the degree of relevance between user terminal 100 and TV receiver 200 when the duration of one connection time is less than 5 minutes, and adds the relevance degree point “+1” to the degree of relevance when the duration of one connection time is 5 minutes or more. Thus, connection state management unit 504 may calculate the degree of relevance based on the duration of one connection time of user terminal 100 and TV receiver 200.

In the example indicated in rule No. 2 in FIG. 7, “a number of times of connection in one day (24 hours)” is set as reference contents, “5 times” is set as a reference value, and “+1” is set to a relevance degree point. Hence, connection state management unit 504 first refers to connection state management table 506 illustrated in FIG. 5 and calculates the number of times of connection in one day when calculating the degree of relevance based on rule No. 2. Further, connection state management unit 504 does not add the relevance degree point to the degree of relevance between user terminal 100 and TV receiver 200 when the number of times of connection in one day is less than 5 times, and adds the relevance degree point “+1” to the degree of relevance when the number of times of connection in one day is 5 times or more. Thus, connection state management unit 504 may calculate the degree of relevance based on the number of times of connection in one day (24 hours) between user terminal 100 and TV receiver 200.

In the example indicated in rule No. 3 in FIG. 7, “whether or not connection is established in a specific time zone” is set as reference contents, “AM 8 o'clock to AM 10 o'clock” and “PM 6 o'clock to PM 12 o'clock” is set as reference values, and “+1” is set to a relevance degree point. Hence, connection state management unit 504 first refers to connection state management table 506 illustrated in FIG. 5, and checks whether or not user terminal 100 and TV receiver 200 are connected between AM 8 o'clock and AM 10 o'clock or between PM 6 o'clock and PM 12 o'clock when calculating the degree of relevance based on rule No. 3. Further, connection state management unit 504 adds the relevance degree point “+1” to the degree of relevance between user terminal 100 and TV receiver 200 when the connection is established, and does not add the relevance degree point to the degree of relevance when the connection is not established. Thus, connection state management unit 504 may calculate the degree of relevance based on whether or not user terminal 100 and TV receiver 200 are connected in a specific time zone.

In an example indicated in rule No. 4 in FIG. 7, “whether or not connection is established on a specific date” is set as reference contents, “December 31” and “January 1” is set as reference values, and “+1” is set to the relevance degree point. Hence, connection state management unit 504 first refers to connection state management table 506 illustrated in FIG. 5, and checks whether or not user terminal 100 and TV receiver 200 are connected on December 31 or January 1 when calculating the degree of relevance based on rule No. 4. Further, connection state management unit 504 adds the relevance degree point “+1” to the degree of relevance between user terminal 100 and TV receiver 200 when the connection is established, and does not add the relevance degree point to the degree of relevance when the connection is not established. Thus, connection state management unit 504 may calculate the degree of relevance based on whether or not user terminal 100 and TV receiver 200 are connected on a specific date.

In an example indicated in rule No. 5 in FIG. 7, “whether or not connection is established on a specific day” is set as reference contents, “Saturday” and “Sunday” is set as reference values, and “+1” is set to the relevance degree point. Hence, connection state management unit 504 first refers to connection state management table 506 illustrated in FIG. 5, and checks whether or not user terminal 100 and TV receiver 200 are connected on Saturday or Sunday when calculating the degree of relevance based on rule No. 5. Further, connection state management unit 504 adds the relevance degree point “+1” to the degree of relevance between user terminal 100 and TV receiver 200 when the connection is established, and does not add the relevance degree point to the degree of relevance when the connection is not established. Thus, connection state management unit 504 may calculate the degree of relevance based on whether or not user terminal 100 and TV receiver 200 are connected on a specific day.

In the example indicated in rule No. 6 in FIG. 7, “whether or not there is a connection record in past” is set as reference contents, “Yes” is set as reference value, and “+1” is set to a relevance degree point. Hence, connection state management unit 504 first refers to connection state management table 506 illustrated in FIG. 5, and checks whether or not user terminal 100 and TV receiver 200 have been previously connected even once when calculating the degree of relevance based on rule No. 6. Further, connection state management unit 504 adds the relevance degree point “+1” to the degree of relevance between user terminal 100 and TV receiver 200 when the connection is established, and does not add the relevance degree point to the degree of relevance when the connection is not established. Thus, connection state management unit 504 may calculate the degree of relevance based on whether or not user terminal 100 and TV receiver 200 have been previously connected.

In the example indicated in rule No. 7 in FIG. 7, “whether or not there is a connection record on a previous day” is set as reference contents, “Yes” is set as a reference value, and “+1.5” is set to a relevance degree point. Hence, connection state management unit 504 first refers to connection state management table 506 illustrated in FIG. 5, and checks whether or not user terminal 100 and TV receiver 200 are connected on a previous day when calculating the degree of relevance based on rule No. 7. Further, connection state management unit 504 adds the relevance degree point “+1.5” to the degree of relevance between user terminal 100 and TV receiver 200 when the connection is established, and does not add the relevance degree point to the degree of relevance when the connection is not established. Thus, connection state management unit 504 may calculate the degree of relevance based on whether or not user terminal 100 and TV receiver 200 are connected on a previous day.

In the example indicated in rule No. 8 in FIG. 7, “first connection on that day” is set as reference contents, “Yes” is set as reference value, and “+0.5” is set to a relevance degree point. Hence, connection state management unit 504 first refers to connection state management table 506 illustrated in FIG. 5, and checks whether or not connection between user terminal 100 and TV receiver 200 is established for the first time on that day when calculating the degree of relevance based on rule No. 8. Further, connection state management unit 504 adds the relevance degree point “+0.5” to the degree of relevance between user terminal 100 and TV receiver 200 when the connection is the first connection on that day, and does not add the relevance degree point to the degree of relevance when the connection is not the first connection. Thus, connection state management unit 504 may calculate the degree of relevance based on whether or not the connection between user terminal 100 and TV receiver 200 is the first time connection on that day.

Further, connection state management unit 504 stores the thus calculated degree of relevance in relevance degree management table 507 illustrated in FIG. 6.

In addition, connection state management unit 504 may place an upper limit on a calculated value of the degree of relevance. This is because, when specific user terminal 100 and TV receiver 200 are connected at all times, the degree of relevance is likely to remarkably high. By placing the upper limit value, it is possible to avoid such a situation. In this case, for example, a fixed value may be set to the upper limit value, or the upper limit value may be calculated by using a function set to moderately increase a calculated value as the calculated value of the degree of relevance becomes higher.

Further, connection state management unit 504 may use all or some of rule Nos. 1 to 8 indicated in relevance degree reference table 508 in FIG. 7 when calculating the degree of relevance.

It should be noted that rules registered in relevance degree reference table 508 are by no means limited to rule Nos. 1 to 8 described above. Each numerical value illustrated in FIG. 7 may be optionally changed. Other rules may be registered in relevance degree reference table 508.

It should be noted that relevance degree management table 507 may be updated, for example, once a day or every preset time. Alternatively, relevance degree management table 507 may be updated at other timings.

[1-5. Flow of Processing of Transmitting Connection State Information from User Terminal to Connection State Management Server]

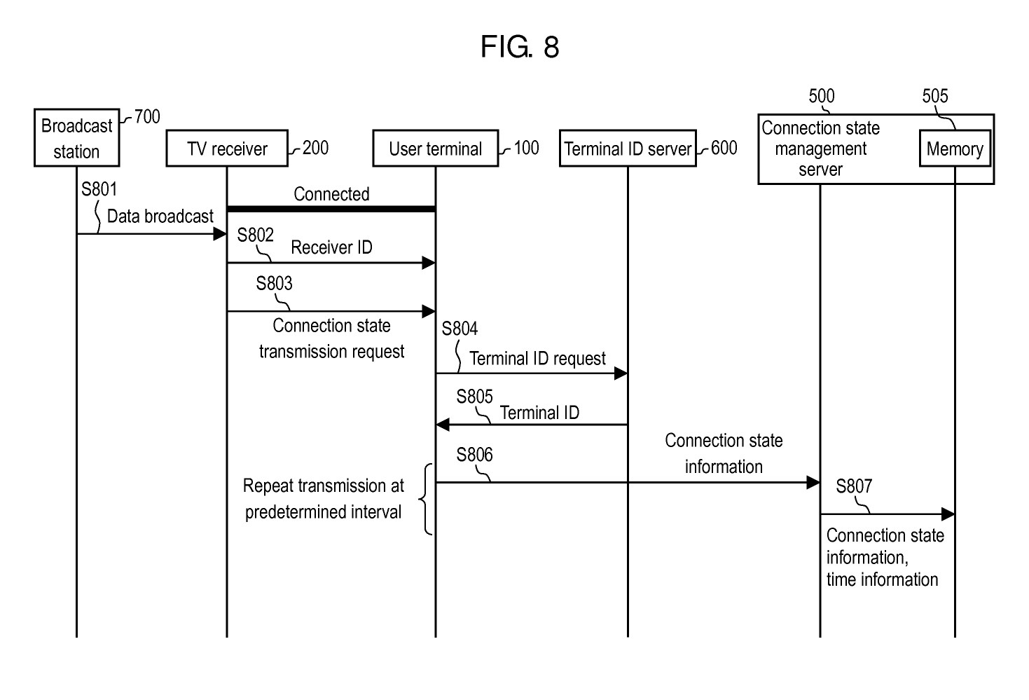

Next, with reference to FIG. 8, a description will be given of a flow of processing of transmitting connection state information from user terminal 100 to connection state management server 500.

Here, the flow will be described below assuming that user terminal 100 and TV receiver 200 have already been connected.

FIG. 8 is a sequence diagram illustrating an example of an operation of transmitting connection state information from user terminal 100 to connection state management server 500 according to the first exemplary embodiment. The sequence diagram in FIG. 8 illustrates a flow of processing of transmitting connection state information from user terminal 100 to connection state management server 500 at a timing at which TV receiver 200 receives data broadcast.

First, data broadcast receiver 203 of TV receiver 200 receives a broadcast wave including data broadcast from broadcast station 700. Data broadcast receiver 203 notifies CPU 205 that data broadcast has been received (step S801).

CPU 205 commands ID management unit 206 to transmit a receiver ID of TV receiver 200 to user terminal 100. ID management unit 206 transmits the receiver ID stored in memory 208, to user terminal 100 through communication controller 204 and network I/F 202 (step S802).

Further, CPU 205 controls connection state transmitter 207 to transmit a connection state transmission request to user terminal 100. Connection state transmitter 207 transmits a connection state transmission request to user terminal 100 through communication controller 204 and network I/F 202 (step S803). This connection state transmission request is made by TV receiver 200 to request user terminal 100 to transmit a connection state of user terminal 100 and TV receiver 200 from user terminal 100 to connection state management server 500.

CPU 103 of user terminal 100 receives the receiver ID and the connection state transmission request transmitted from TV receiver 200 through wireless I/F 101 and communication controller 102. CPU 103 commands ID management unit 105 to store the received receiver ID in memory 104. Thus, ID management unit 105 stores the receiver ID in memory 104. Further, ID management unit 105 transmits a terminal ID request to terminal ID server 600 through communication controller 102 and wireless I/F 101 to obtain a terminal ID from terminal ID server 600 when the terminal ID of user terminal 100 is not stored in memory 104 (step S804). The terminal ID request is made by user terminal 100 to request terminal ID server 600 to transmit the terminal ID of user terminal 100 from terminal ID server 600 to user terminal 100.

When receiving the terminal ID request from user terminal 100, terminal ID server 600 generates the terminal ID of the user terminal 100, and transmits the terminal ID to user terminal 100. ID management unit 105 of user terminal 100 obtains this terminal ID through wireless I/F 101 and communication controller 102. Further, the ID management unit 105 stores the obtained terminal ID in memory 104 (step S805).

CPU 103 controls connection state transmitter 106 to transmit a connection state to connection state management server 500. Connection state transmitter 106 transmits connection state information to connection state management server 500 through communication controller 102 and wireless I/F 101 when user terminal 100 and TV receiver 200 are connected. This operation is performed at a predetermined interval (e.g., every one minute) (step S806). In addition, user terminal 100 does not transmit connection state information to connection state management server 500 when user terminal 100 and TV receiver 200 are not connected. Further, this connection state information is a pair of the terminal ID of user terminal 100 stored in memory 104 and the receiver ID of TV receiver 200.

Connection state management unit 504 of connection state management server 500 stores connection state information received through network I/F 501 and communication controller 502, and time information of a time at which the connection state information is received, in connection state management table 506 in memory 505 in association with each other. Connection state management unit 504 performs this operation at a predetermined interval (e.g., every one minute). However, connection state management unit 504 stores only time information indicating a scheduled reception time in connection state management table 506 when the connection state information cannot be received at the scheduled reception time calculated based on a predetermined interval. Further, connection state management unit 504 calculates the degree of relevance between user terminal 100 and TV receiver 200 by using connection state management table 506 and relevance degree reference table 508 stored in memory 505. Further, the degree of relevance between user terminal 100 and TV receiver 200 in relevance degree management table 507 stored in memory 505 is updated to the calculated degree of relevance (step S807). The method for calculating the degree of relevance is as described above.

Thus, connection state management server 500 can manage the terminal ID of user terminal 100 and the receiver ID of TV receiver 200, and the degree of relevance between user terminal 100 and TV receiver 200, in association with each other.

[1-6. Flow of Processing of Advertisement Distribution System]

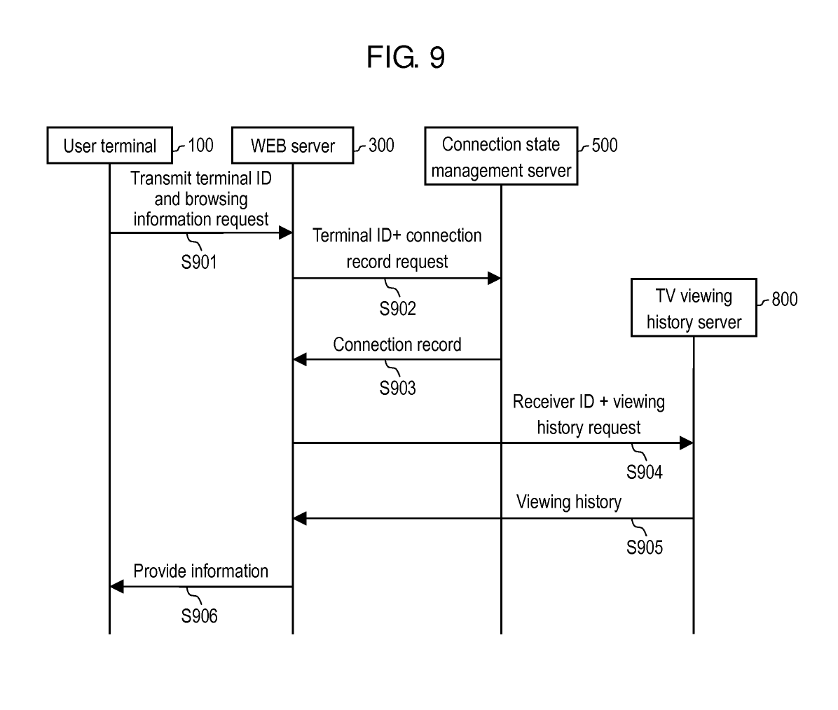

Next, with reference to FIG. 9, a description will be given of an example of a flow of processing of providing information from web server 300 to user terminal 100 based on information provided from information providing system 20.

FIG. 9 is a sequence diagram illustrating an example of an operation of advertisement distribution system 10 according to the first exemplary embodiment.

The sequence diagram in FIG. 9 illustrates the flow of processing of providing information taking into account user's interest (e.g., advertisement information reflecting user's interest) from web server 300 to user terminal 100 in advertisement distribution system 10.

When the user browses webpages using user terminal 100, user terminal 100 transmits a browsing information request for requesting browsing information, and the terminal ID of user terminal 100 to web server 300 (step S901).

When receiving the browsing information request and the terminal ID from user terminal 100, web server 300 transmits the terminal ID and a connection record request to connection state management server 500. The connection record request is made by web server 300 to request connection state management server 500 to provide a connection record of user terminal 100 and TV receiver 200. The connection record requested in this case includes, for example, the receiver ID of TV receiver 200 which has a past record of connection with user terminal 100 specified based on the terminal ID, the degree of relevance between TV receiver 200 associated with the receiver ID and user terminal 100, a connection time, a connection duration, and the like (step S902).

When receiving the terminal ID and the connection record request from web server 300, connection state management server 500 transmits to web server 300 the receiver ID of TV receiver 200 which has a record of connection with user terminal 100 specified based on the terminal ID, the degree of relevance between user terminal 100 and TV receiver 200, time information of a time at which user terminal 100 and TV receiver 200 were connected at last time, and connection time information of the last time connection. Further, when there are a plurality of TV receivers 200 which have records of connection with this user terminal 100, connection state management server 500 transmits the same pieces of information related to a plurality of TV receivers 200, to web server 300 (step S903).

When receiving information related to the connection record from connection state management server 500, web server 300 transmits a viewing history request to TV viewing history server 800 (step S904). This viewing history request is made by web server 300 to request TV viewing history server 800 to send a viewing history in TV receiver 200 associated with the receiver ID included in the information of the connection record received by web server 300.

In addition, in the present exemplary embodiment, the operation of the web server 300 is not limited at all. However, the web server 300 may generate a viewing history request based on conditions set as follows, for example.

1) Web server 300 requests TV viewing history server 800 to send a TV viewing history for a predetermined period (e.g., past one month from a current point of time) in TV receiver 200 associated with the receiver ID whose degree of relevance is a predetermined value or more.

2) Web server 300 first obtains time information of last time connection of TV receiver 200 associated with the receiver ID whose degree of relevance is less than a predetermined value. Further, web server 300 specifies a connection period of the last time connection based on the obtained time information. Furthermore, web server 300 requests TV viewing history server 800 to send a TV viewing history for a specified period (e.g., between PM 1 o'clock and PM 3 o'clock on a previous day).

This “predetermined value” is desirably set adequately to obtain intended effects.

In addition, the above operation is simply an operation example of web server 300, and web server 300 may perform other operations. For example, when a plurality of receiver IDs are included in the received information of a connection record, web server 300 may request TV viewing history server 800 to send only a viewing history of TV receiver 200 associated with the receiver ID whose degree of relevance is the highest.

When receiving the viewing history request, TV viewing history server 800 obtains the viewing history based on the viewing history request from viewing history DB 900. More specifically, TV viewing history server 800 obtains a viewing history for a period designated by the viewing history request in TV receiver 200 associated with the receiver ID included in the viewing history request, from viewing history DB 900. Further, TV viewing history server 800 transmits the obtained viewing history to web server 300 (step S905).

Web server 300 receives the viewing history from TV viewing history server 800. Further, web server 300 obtains a web browsing history of user terminal 100 from web browsing history DB 400 by using information for specifying user terminal 100 (e.g., the terminal ID of user terminal 100). Web server 300 selects information which is provided to user terminal 100 (e.g., advertisement information), by using the viewing history of TV receiver 200 and the web browsing history of user terminal 100, and transmits the selected information to user terminal 100 (step S906).

In this case, web server 300 may select information to be provided to user terminal 100, based on a score of a numerical value of the degree of relevance. For example, it is considered that a viewing history of TV receiver 200 associated with the receiver ID whose numerical value of the degree of relevance is high strongly reflects user's interest. Consequently, web server 300 can enhance precision of estimation by, for example, estimating user's interest based on the viewing history of TV receiver 200 associated with the receiver ID whose numerical value of the degree of relevance is high. Consequently, by selecting information to be provided to user terminal 100 based on this estimation, web server 300 can enhance precision to select information.

In addition, whether the numerical value of the degree of relevance is high or low may be determined by, for example, comparing a preset threshold with the degree of relevance. Alternatively, whether the degree of relevance is high or low may be determined by comparing the degrees of relevance of a plurality of receivers ID with each other.

[1-7. Flow of Processing of Transmitting Connection State Information from TV Receiver to Connection State Management Server]

FIG. 8 illustrates an example of an operation of transmitting connection state information from user terminal 100 to connection state management server 500. However, the present exemplary embodiment is by no means limited to this operation. For example, connection state information may be transmitted from TV receiver 200 to connection state management server 500.

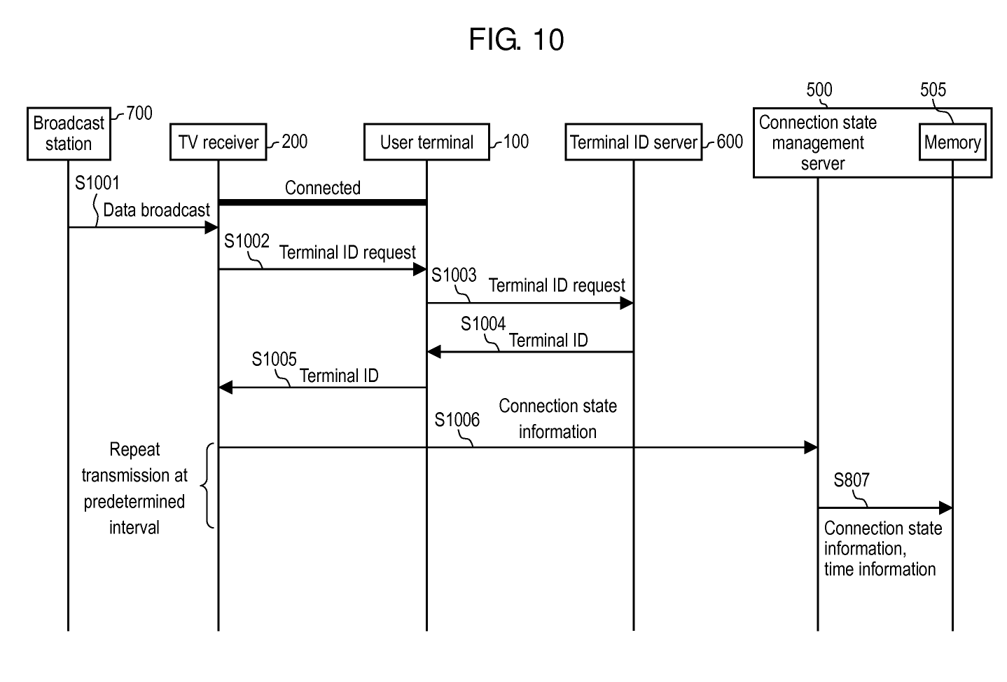

With reference to FIG. 10, a description will now be given of a flow of processing of transmitting a terminal ID for specifying user terminal 100 and a receiver ID of TV receiver 200 from TV receiver 200 to connection state management server 500. In addition, the flow will be described below assuming that user terminal 100 and TV receiver 200 have already been connected.

FIG. 10 is a sequence diagram illustrating an example of an operation of transmitting connection state information from TV receiver 200 to connection state management server 500 according to the first exemplary embodiment. The sequence diagram in FIG. 10 illustrates a flow of processing of transmitting the terminal ID for specifying user terminal 100 and the receiver ID of TV receiver 200 from TV receiver 200 to connection state management server 500 at a timing at which TV receiver 200 receives data broadcast.

First, data broadcast receiver 203 of TV receiver 200 receives a broadcast wave including data broadcast from broadcast station 700. Data broadcast receiver 203 notifies CPU 205 that data broadcast has been received (step S1001).

CPU 205 transmits a terminal ID request to user terminal 100 through communication controller 204 and network I/F 202 (step S1002). The terminal ID request is made by TV receiver 200 to request user terminal 100 to transmit the terminal ID of user terminal 100 to TV receiver 200.

When receiving the terminal ID request transmitted from TV receiver 200 through wireless I/F 101 and communication controller 102, CPU 103 of user terminal 100 controls ID management unit 105 to transmit the terminal ID of user terminal 100 to TV receiver 200. ID management unit 105 transmits a terminal ID request to terminal ID server 600 through communication controller 102 and wireless I/F 101 to obtain a terminal ID from terminal ID server 600 when the terminal ID of user terminal 100 is not stored in memory 104 (step S1003).

When receiving the terminal ID request from user terminal 100, terminal ID server 600 generates the terminal ID of the user terminal 100, and transmits the terminal ID to user terminal 100. ID management unit 105 of user terminal 100 obtains this terminal ID through wireless I/F 101 and communication controller 102. Further, the ID management unit 105 stores the obtained terminal ID in memory 104 (step S1004).

ID management unit 105 transmits the terminal ID obtained from terminal ID server 600 and stored in memory 104, to TV receiver 200 through communication controller 102 and wireless I/F 101 based on a command from CPU 103 (step S1005).

CPU 205 of TV receiver 200 receives the terminal ID of user terminal 100 through network I/F 202 and communication controller 204. Further, CPU 205 outputs the received terminal ID to ID management unit 206. ID management unit 206 stores the terminal ID output from CPU 205, in memory 208. CPU 205 controls connection state transmitter 207 to transmit connection state information to connection state management server 500. Connection state transmitter 207 transmits connection state information to connection state management server 500 through communication controller 204 and network I/F 202 when user terminal 100 and TV receiver 200 are connected. This operation is performed at a predetermined interval (e.g., every one minute) (step S1006). In addition, TV receiver 200 does not transmit connection state information to connection state management server 500 when user terminal 100 and TV receiver 200 are not connected. Further, this connection state information is a pair of the terminal ID of user terminal 100 stored in memory 208 and the receiver ID of TV receiver 200.

Connection state management server 500 performs the same processing as that in step S807 in FIG. 8, and updates contents of connection state management table 506 and relevance degree management table 507 stored in memory 505 by using the received connection state information and time information (step S807).

Thus, connection state management server 500 can manage the terminal ID of user terminal 100 and the receiver ID of TV receiver 200, and the degree of relevance between user terminal 100 and TV receiver 200, in association with each other.

[1-8. Effect and Others]

As described above, information providing system 20 according to the present exemplary embodiment includes TV receiver 200 connectable to network 30, user terminal 100 connectable to network 30, and connection state management server 500 connectable to network 30. User terminal 100 can execute a program for connecting with TV receiver 200. Connection state management server 500 obtains connection state information including an identifier of TV receiver 200 and an identifier of user terminal 100 from one of TV receiver 200 and user terminal 100 which are connected to each other, through network 30. Further, connection state management server 500 scores the degree of relevance representing a level of relevance between TV receiver 200 and user terminal 100 connected to each other, based on the obtained connection state information. Furthermore, connection state management server 500 provides the scored degree of relevance in response to a request from an outside.

In addition, the terminal ID is an example of an identifier of user terminal 100. The receiver ID is an example of an identifier of TV receiver 200. Web server 300 is an example of a request source which requests the degree of relevance.

Hence, in information providing system 20, connection state management server 500 includes one or more rules for scoring the degree of relevance. A reference value to be compared with information obtained from the connection state information, and a relevance degree point to be added to the degree of relevance based on the comparison result are registered for each rule in advance in association with each other.

Consequently, connection state management server 500 can score the degree of relevance as a relatively large numerical value when relevance between TV receiver 200 and user terminal 100 connected to each other is relatively high, and score the degree of relevance as a relatively small numerical value when the relevance is relatively low.

Thus, connection state management server 500 can express a level of relevance between TV receiver 200 and user terminal 100 connected to each other by using a numerical value. That is, the scored degree of relevance represents the level of relevance between TV receiver 200 and user terminal 100 connected to each other as a score of a numerical value.

Consequently, it is possible to determine the level of relevance between user terminal 100 and TV receiver 200 connected to user terminal 100 by referring to the degree of relevance.

In view of this, a server which distributes advertisement information to user terminal 100 (an advertisement distribution server, such as web server 300) can specify TV receiver 200 whose relevance with user terminal 100 is high, by obtaining the degree of relevance from connection state management server 500.

As described above, according to the conventional technique, for example, the advertisement distribution server which distributes advertisement information to user terminal 100 determines advertisement information to be distributed to user terminal 100, based on a browsing history of webpages stored in user terminal 100.

However, user terminal 100 can display a great amount of information to be distributed through network 30 one after another in a short time. Therefore, the owner of user terminal 100 does not necessarily browse only webpages in which the owner is highly interested and webpages in which the owner is not highly interested are likely to be included in a browsing history. Hence, when the advertisement distribution server estimates owner's interest by using only a browsing history of webpages and determines advertisement information to be distributed to user terminal 100 based on this estimation, the advertisement information is likely to include advertisement of a product in which the owner is not interested.

In the case where the advertisement distribution server can obtain a program viewing history of TV receiver 200 from, for example, TV viewing history server 800, the advertisement distribution server can also obtain and use the program viewing history of TV receiver 200 to estimate owner's interest.

Compared to a browsing history of webpages on user terminal 100 which can display a great amount of information to be distributed through network 30 one after another in a short time, a viewing history of programs in TV receiver 200 which receives broadcast signals transmitted from broadcast station 700 and displays programs is highly likely to relatively strongly reflect the interest of the user who uses TV receiver 200.

However, when the program viewing history obtained by the advertisement distribution server is a history of TV receiver 200 whose relevance with the owner of user terminal 100 is low, the advertisement distribution server cannot increase precision to estimate owner's interest even if the program viewing history is used.

Meanwhile, when the program viewing history obtained by the advertisement distribution server is a history of TV receiver 200 whose relevance with the owner of user terminal 100 is high, the program viewing history of TV receiver 200 is likely to reflect owner's interest of user terminal 100. Consequently, when the advertisement distribution server selects advertisement information to be distributed to user terminal 100 based on the program viewing history, this advertisement information is likely to be advertisement of a product in which the owner of user terminal 100 is interested.

As described above, information providing system 20 according to the present exemplary embodiment can provide the degree of relevance obtained by scoring the level of relevance between TV receiver 200 and user terminal 100 connected to each other, from connection state management server 500 to a request source which requests the degree of relevance (e.g., advertisement distribution server). Consequently, the request source (e.g., advertisement distribution server) can specify TV receiver 200 whose relevance with user terminal 100 is high, based on the obtained degree of relevance.

For example, the advertisement distribution server which has obtained the degree of relevance can specify TV receiver 200 whose relevance with user terminal 100 is high, based on the degree of relevance. Consequently, by obtaining and using a program viewing history of this TV receiver 200, the advertisement distribution server can enhance precision to estimate owner's interest of user terminal 100. Consequently, advertisement information selected by the advertisement distribution server based on this program viewing history is highly likely to be advertisement of a product in which the owner of user terminal 100 is interested.

In addition, the present exemplary embodiment does not limit a method for using the degree of relevance provided from information providing system 20 (connection state management server 500) to the outside at all, and the above example is merely an exemplary method for using the degree of relevance.

In information providing system 20, connection state management server 500 may include a rule for scoring the degree of relevance based on connection state information and a time at which the connection state information is received.

Thus, connection state management server 500 can calculate the degree of relevance based on the rules, such as rules No. 1, 2, 3, 6, 7 and 8 illustrated in FIG. 7, which are set in association with a reception time of the connection state information.

In information providing system 20, connection state management server 500 may include a rule for scoring the degree of relevance based on connection state information and a date on which the connection state information is received.

Thus, connection state management server 500 can calculate the degree of relevance based on the rule, such as rule No. 4 illustrated in FIG. 7, which is set in association with a reception date of the connection state information.

In information providing system 20, connection state management server 500 may include a rule for scoring the degree of relevance based on connection state information and a day on which the connection state information is received.

Thus, connection state management server 500 can calculate the degree of relevance based on the rule, such as rule No. 5 illustrated in FIG. 7, which is set in association with a reception day of the connection state information.

In information providing system 20, one of TV receiver 200 and user terminal 100 connected to each other may transmit the connection state information to connection state management server 500 through network 30. Further, connection state management server 500 may obtain the connection state information through network 30.

Information providing system 20 may transmit connection state information at a timing at which TV receiver 200 receives a broadcast wave.

Information providing system 20 may further include terminal ID server 600 which generates an identifier of user terminal 100 and transmits the identifier to user terminal 100 through network 30. Further, user terminal 100 may obtain the identifier of user terminal 100 from terminal ID server 600 through network 30.

### Second Exemplary Embodiment

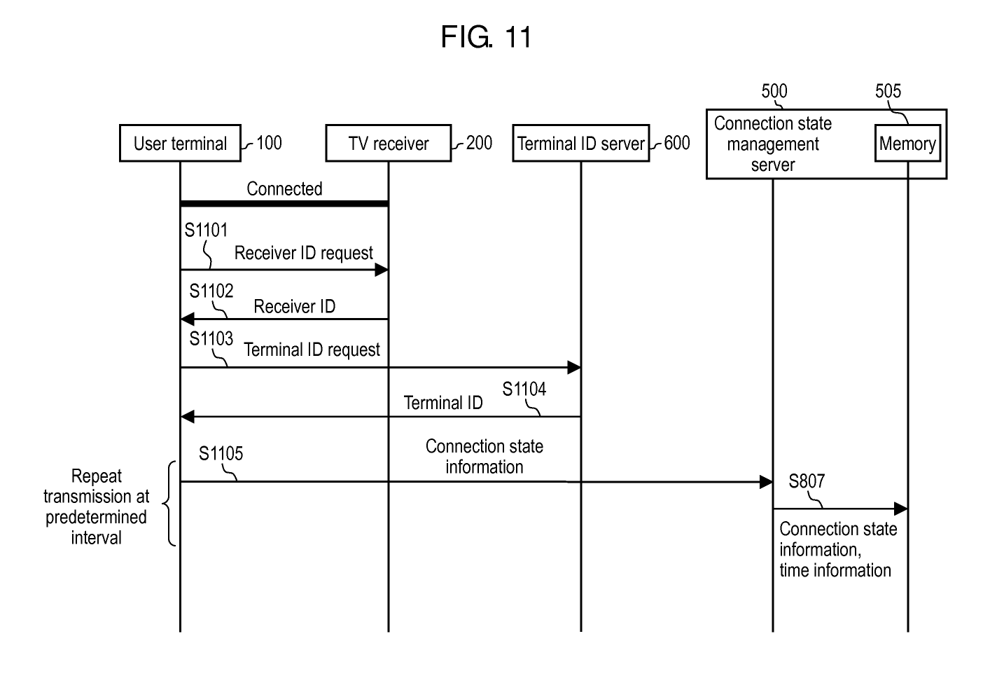

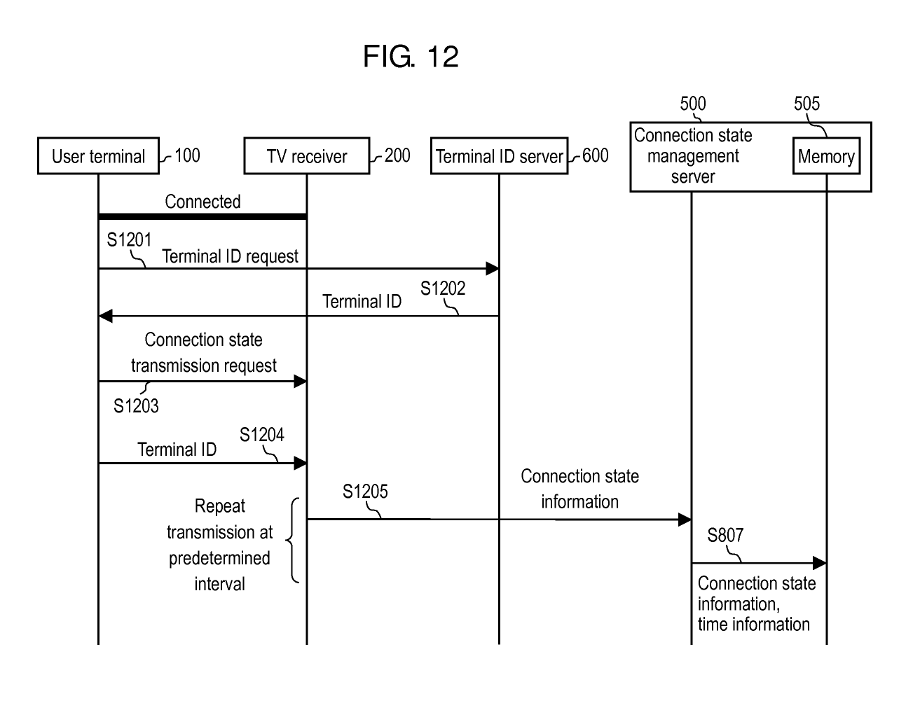

A second exemplary embodiment will be described below with reference to FIGS. 11 and 12.

It should be noted that an information providing system according to the second exemplary embodiment is substantially the same as information providing system 20 described in the first exemplary embodiment, and therefore the configuration and components of the information providing system will not be described.

[2-1. Flow of Processing of Transmitting Connection State Information from User Terminal to Connection State Management Server]

The flow of processing of transmitting the connection state information from user terminal 100 to connection state management server 500 at the timing at which TV receiver 200 receives data broadcast has been described in the first exemplary embodiment with reference to FIG. 8. However, the present disclosure is by no means limited to this. In the second exemplary embodiment, an example of an operation performed at a timing of an operation different from that of the first exemplary embodiment will be described.

With reference to FIG. 11, a description will be given below of flow of processing of transmitting a user terminal ID for specifying user terminal 100 and a receiver ID of TV receiver 200 connected with user terminal 100, from user terminal 100 to connection state management server 500 (i.e., processing of transmitting the connection state information to connection state management server 500).

In addition, the flow will be described below assuming that user terminal 100 and TV receiver 200 have already been connected.

Further, it is assumed that an application (hereinafter, referred to as a “TV link application”) which allows user terminal 100 to be used in conjunction with TV receiver 200 is installed in user terminal 100. An example of the TV link application includes a remote controller application which allows user terminal 100 to perform a channel operation or change a volume of TV receiver 200. However, the TV link application is by no means limited to the remote controller application, and may be another application.

In addition, the TV link application is configured to output, to CPU 103, a command for commanding user terminal 100 to transmit a connection state of user terminal 100 and TV receiver 200 to connection state management server 500.

In the second exemplary embodiment, a description will be given of an example of an operation of updating the degree of relevance between user terminal 100 and TV receiver 200 at a timing at which the TV link application is activated in user terminal 100 (or a timing which is set in advance to the TV link application).

FIG. 11 is a sequence diagram illustrating an example of an operation of transmitting connection state information from user terminal 100 to connection state management server 500 according to the second exemplary embodiment.

First, CPU 103 of user terminal 100 receives from the TV link application a command for commanding user terminal 100 to transmit a connection state of user terminal 100 and TV receiver 200 to connection state management server 500. This command is output from TV link application to CPU 103, for example, at a timing at which user terminal 100 activates the TV link application or at a timing which is set to the TV link application in advance. When the receiver ID of TV receiver 200 is not stored in memory 104, CPU 103 controls ID management unit 105 to transmit a receiver ID request to TV receiver 200 (step S1101). The receiver ID request is to request TV receiver 200 to transmit the receiver ID of TV receiver 200 to user terminal 100.

When receiving the receiver ID request transmitted from user terminal 100 through network I/F 202 and communication controller 204, CPU 205 of TV receiver 200 commands ID management unit 206 to transmit the receiver ID to user terminal 100. ID management unit 206 transmits the receiver ID stored in memory 208, to user terminal 100 through communication controller 204 and network I/F 202. ID management unit 105 of user terminal 100 stores in memory 104 the receiver ID of TV receiver 200 received through wireless I/F 101 and communication controller 102 (step S1102).

ID management unit 105 transmits a terminal ID request to terminal ID server 600 through communication controller 102 and wireless I/F 101 to obtain a terminal ID from terminal ID server 600 when the terminal ID of user terminal 100 is not stored in memory 104 (step S1103).

When receiving the terminal ID request from user terminal 100, terminal ID server 600 generates the terminal ID of the user terminal 100, and transmits the terminal ID to user terminal 100. ID management unit 105 of user terminal 100 obtains this terminal ID through wireless I/F 101 and communication controller 102. Further, the ID management unit 105 stores the obtained terminal ID in memory 104 (step S1104).

CPU 103 controls connection state transmitter 106 to transmit a connection state to connection state management server 500. Connection state transmitter 106 transmits connection state information to connection state management server 500 through communication controller 102 and wireless I/F 101 when user terminal 100 and TV receiver 200 are connected. This operation is performed at a predetermined interval (e.g., every one minute) (step S1105). In addition, user terminal 100 does not transmit connection state information to connection state management server 500 when user terminal 100 and TV receiver 200 are not connected. Further, this connection state information is a pair of the terminal ID of user terminal 100 obtained from terminal ID server 600 and the receiver ID obtained from TV receiver 200.

Connection state management server 500 performs the same processing as that in step S807 in FIG. 8, and updates contents of connection state management table 506 and relevance degree management table 507 stored in memory 505 by using the received connection state information and time information (step S807).

Thus, connection state management server 500 can manage the terminal ID of user terminal 100 and the receiver ID of TV receiver 200, and the degree of relevance between user terminal 100 and TV receiver 200, in association with each other.

[2-2. Flow of Processing of Transmitting Connection State Information from TV Receiver to Connection State Management Server]

FIG. 11 illustrates an example of an operation of transmitting connection state information of user terminal 100 and TV receiver 200 from user terminal 100 to connection state management server 500. However, the present exemplary embodiment is by no means limited to this operation. For example, connection state information may be transmitted from TV receiver 200 to connection state management server 500.

With reference to FIG. 12, a description will now be given of a flow of processing of transmitting a terminal ID for specifying user terminal 100 and a receiver ID of TV receiver 200 from TV receiver 200 to connection state management server 500. In addition, the flow will be described below assuming that user terminal 100 and TV receiver 200 have already been connected.

Further, it is assumed that the TV link application which allows user terminal 100 to be used in conjunction with TV receiver 200 is installed in user terminal 100. In addition, the TV link application is configured to output, to CPU 103, a command for commanding user terminal 100 to transmit a connection state of user terminal 100 and TV receiver 200 to connection state management server 500.

FIG. 12 is a sequence diagram illustrating an example of an operation of transmitting connection state information from TV receiver 200 to connection state management server 500 according to the second exemplary embodiment.

First, CPU 103 of user terminal 100 receives from the TV link application a command for commanding user terminal 100 to transmit a connection state of user terminal 100 and TV receiver 200 to connection state management server 500. This command is output from TV link application to CPU 103, for example, at a timing at which user terminal 100 activates the TV link application or at a timing which is set to the TV link application in advance.

ID management unit 105 transmits a terminal ID request to terminal ID server 600 through communication controller 102 and wireless I/F 101 to obtain a terminal ID from terminal ID server 600 when the terminal ID of user terminal 100 is not stored in memory 104 (step S1201).

When receiving the terminal ID request from user terminal 100, terminal ID server 600 generates the terminal ID of the user terminal 100, and transmits the terminal ID to user terminal 100. ID management unit 105 of user terminal 100 obtains this terminal ID through wireless I/F 101 and communication controller 102. Further, the ID management unit 105 stores the obtained terminal ID in memory 104 (step S1202).

CPU 103 controls connection state transmitter 106 to transmit a connection state transmission request to TV receiver 200. Connection state transmitter 106 transmits a connection state transmission request to TV receiver 200 through communication controller 102 and wireless I/F 101 (step S1203). This connection state transmission request is made by user terminal 100 to request TV receiver 200 to transmit a connection state of user terminal 100 and TV receiver 200 from TV receiver 200 to connection state management server 500.

ID management unit 105 transmits the terminal ID obtained from terminal ID server 600 and stored in memory 104, to TV receiver 200 through communication controller 102 and wireless I/F 101 based on a command from CPU 103 (step S1204).

CPU 205 of TV receiver 200 receives the terminal ID of user terminal 100 through network I/F 202 and communication controller 204. Further, CPU 205 outputs the received terminal ID to ID management unit 206. ID management unit 206 stores the terminal ID output from CPU 205, in memory 208. CPU 205 controls connection state transmitter 207 to transmit connection state information to connection state management server 500. Connection state transmitter 207 transmits connection state information to connection state management server 500 through communication controller 204 and network I/F 202 when user terminal 100 and TV receiver 200 are connected. This operation is performed at a predetermined interval (e.g., every one minute) (step S1205). In addition, TV receiver 200 does not transmit connection state information to connection state management server 500 when user terminal 100 and TV receiver 200 are not connected. Further, this connection state information is a pair of the terminal ID of user terminal 100 stored in memory 208 and the receiver ID of TV receiver 200.

Connection state management server 500 performs the same processing as that in step S807 in FIG. 8, and updates contents of connection state management table 506 and relevance degree management table 507 stored in memory 505 by using the received connection state information and time information (step S807).

Thus, connection state management server 500 can manage the terminal ID of user terminal 100 and the receiver ID of TV receiver 200, and the degree of relevance between user terminal 100 and TV receiver 200, in association with each other.

[2-3. Effect and Others]

As described above, the information providing system according to the present exemplary embodiment transmits connection state information at a timing at which user terminal 100 executes a program for connecting with TV receiver 200.

Consequently, similar to the first exemplary embodiment, connection state management server 500 can score the degree of relevance as a relatively large numerical value when relevance between TV receiver 200 and user terminal 100 connected to each other is relatively high, and score the degree of relevance as a relatively small numerical value when the relevance is relatively low.

### Third Exemplary Embodiment

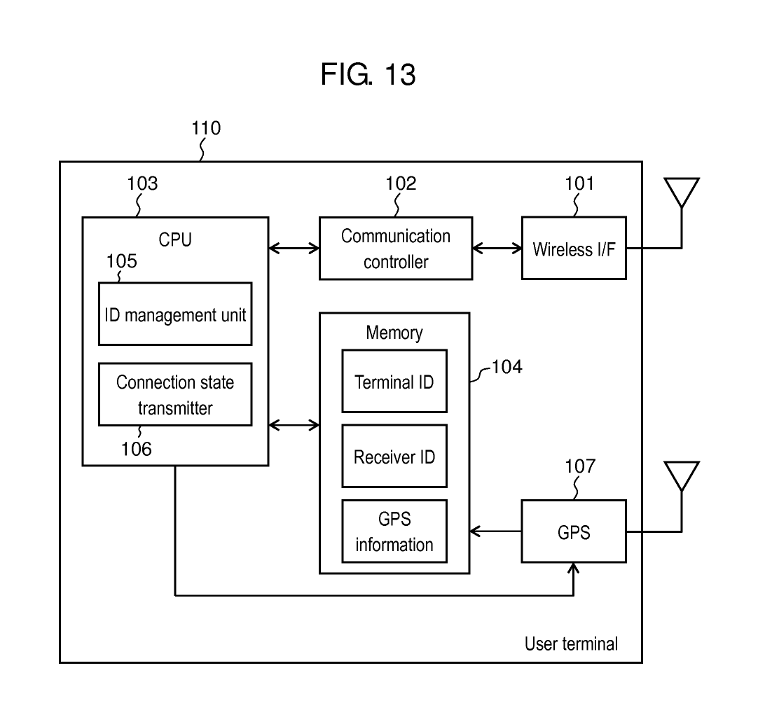

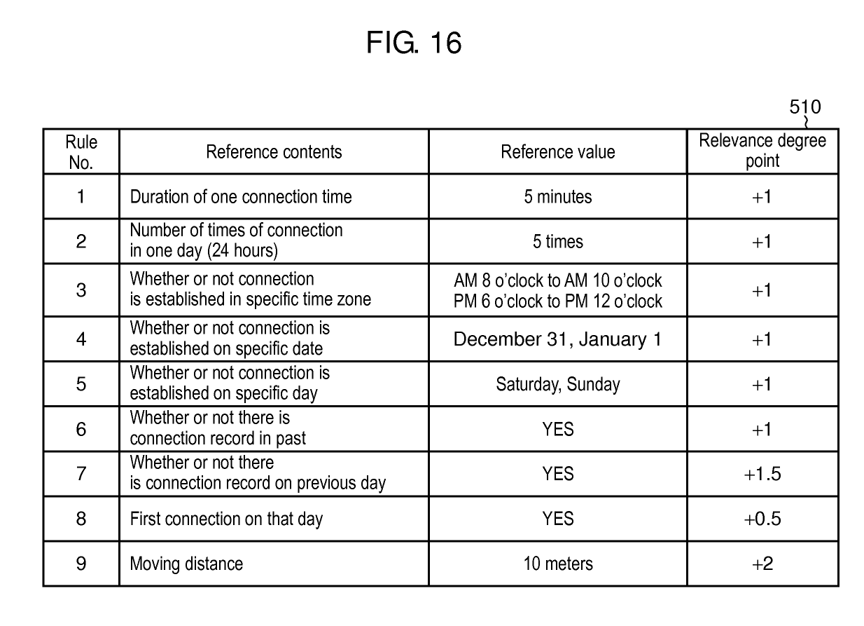

Next, a third exemplary embodiment will be described with reference to FIGS. 13 and 16.

An information providing system according to the third exemplary embodiment is substantially the same as information providing system 20 described in the first exemplary embodiment, and therefore the configuration and components of the information providing system will not be described.

That is, a configuration and an operation of user terminal 110 according to the third exemplary embodiment are substantially the same as those of user terminal 100 described in the first exemplary embodiment, and a configuration and an operation of TV receiver 210 according to the third exemplary embodiment are substantially the same as those of TV receiver 200 described in the first exemplary embodiment.

Meanwhile, user terminal 110, TV receiver 210 and connection state management server 500 according to the third exemplary embodiment differ from user terminal 100, TV receiver 200 and connection state management server 500 according to the first exemplary embodiment, at a point of using position information obtained by using GPS (Global Positioning System).

Differences from the first exemplary embodiment will be described below.

[3-1-1. Configuration of User Terminal]

FIG. 13 is a block diagram illustrating a configuration example of user terminal 110 according to the third exemplary embodiment.

As illustrated in FIG. 13, user terminal 110 includes wireless I/F 101, communication controller 102, CPU 103, memory 104, and GPS 107. Wireless I/F 101, communication controller 102, and memory 104 are substantially the same as blocks of user terminal 100 described in the first exemplary embodiment, and therefore will not be described.

GPS 107 includes an antenna which communicates with GPS satellites. GPS 107 receives data from a GPS satellite when necessary, calculates position information based on the received data and stores the calculated position information as GPS information in memory 104. The GPS information is information which makes it possible to specify the position of user terminal 110, and includes, for example, latitude information and longitude information. That is, this GPS information is position information indicating the position of user terminal 110.

In addition, a timing at which GPS 107 receives data from a GPS satellite may be set in advance or according to a command from CPU 103.

CPU 103 also performs an operation of commanding GPS 107 to receive data from a GPS satellite, calculate position information based on the received data, and store the calculated position information in memory 104, in addition to the execution of the operation described in the first exemplary embodiment.

Further, CPU 103 commands connection state transmitter 106 to transmit, to connection state management server 500, connection state information including a terminal ID and a receiver ID described in the first exemplary embodiment and GPS information.

Connection state transmitter 106 also transmits connection state information including the terminal ID, the receiver ID, and the GPS information to connection state management server 500 according to a command of CPU 103, in addition to the execution of the operation described in the first exemplary embodiment.

The configuration and the operation of user terminal 110 are substantially the same as user terminal 100 described in the first exemplary embodiment except this point.

[3-1-2. Configuration of TV Receiver]

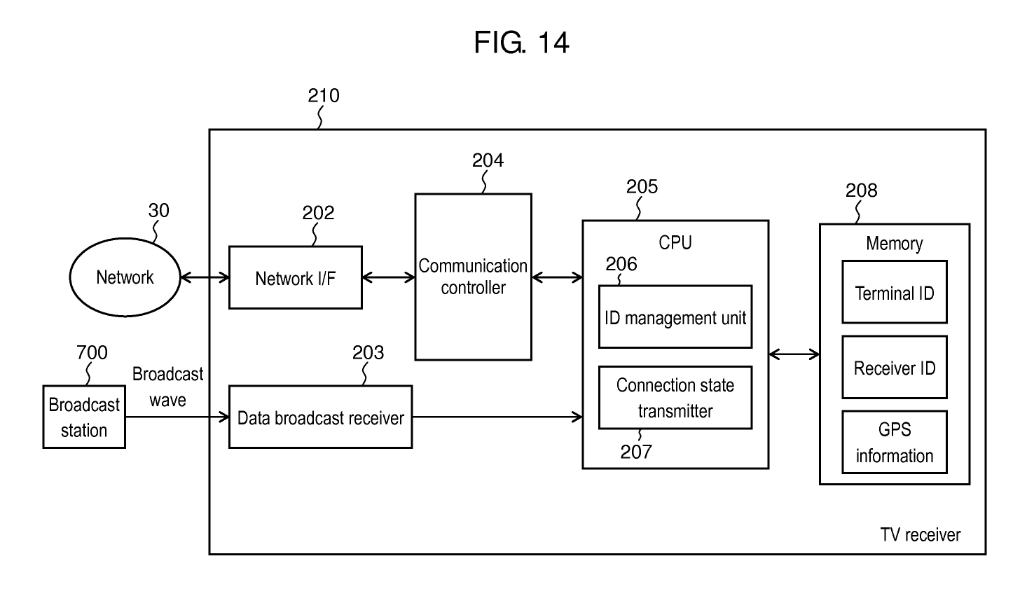

FIG. 14 is a block diagram illustrating a configuration example of TV receiver 210 according to the third exemplary embodiment.

As illustrated in FIG. 14, TV receiver 210 includes network I/F 202, data broadcast receiver 203, communication controller 204, CPU 205 and memory 208. Further, CPU 205 includes ID management unit 206 and connection state transmitter 207.

Memory 208 stores the terminal ID and the receiver ID described in the first exemplary embodiment, and GPS information transmitted from user terminal 110. Further, connection state transmitter 207 transmits the terminal ID and the receiver ID described in the first exemplary embodiment, and GPS information (i.e., position information of user terminal 110) when transmitting connection state information to connection state management server 500.

The configuration and the operation of TV receiver 210 are substantially the same as TV receiver 200 described in the first exemplary embodiment except this point.

[3-1-3. Configuration of Connection State Management Server]

The configuration and the operation of the connection state management server according to the third exemplary embodiment are substantially the same as the configuration and the operation of connection state management server 500 described in the first exemplary embodiment, and therefore will not be described.

Meanwhile, a connection state management unit of the connection state management server according to the third exemplary embodiment stores, in the connection state management table, a terminal ID, a receiver ID and time information of connection state management table 506 described in the first exemplary embodiment, and GPS information (i.e., position information of user terminal 110).

Further, in the relevance degree reference table in the third exemplary embodiment, rules of relevance degree reference table 508 described in the first exemplary embodiment, and a rule for using GPS information are registered.

The connection state management server according to the third exemplary embodiment differs from connection state management server 500 described in the first exemplary embodiment in this point.

Next, these tables will be described.

[3-2. Configuration of Connection State Management Table]

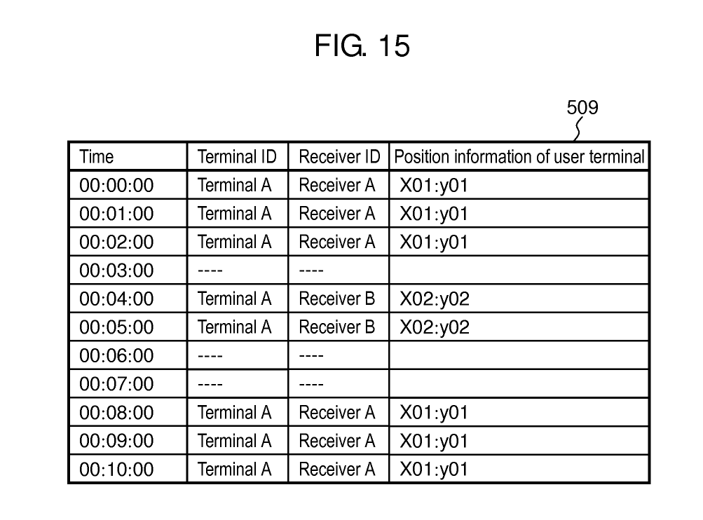

FIG. 15 is a diagram illustrating an example of connection state management table 509 held in a connection state management server according to the third exemplary embodiment.

As illustrated in FIG. 15, connection state management table 509 according to the third exemplary embodiment stores information representing times, terminal IDs, and receiver IDs which are indicated in connection state management table 506 in FIG. 5, and position information of user terminal 110 (GPS information obtained by user terminal 110) in association with each other. In addition, FIG. 15 illustrates an example where the predetermined interval is “one minute”. However, this interval is by no means limited to one minute.

In addition, in FIG. 15, information of XY coordinates indicated as position information of user terminal 110 indicates a position of user terminal 110 at a time indicated by time information. For example, “x01:y01” at time 00:00:00 indicates a position of terminal A connected to receiver A at time 00:00:00.

FIG. 15 illustrates a case an example where connection state management server 500 receives connection state information every minute from time 00:00:00 to time 00:10:59, and does not receive the connection state information at time 00:03:00, time 00:06:00 and time 00:07:00 which are scheduled reception times.

In the example illustrated in FIG. 15, connection state management server 500 determines that terminal A is at position “x01:y01” and is connected with receiver A in a period from time 00:00:00 to time 00:02:59. Further, connection state management server 500 determines that user terminal 110 and TV receiver 210 are not connected in a period from time 00:03:00 to time 00:04:59. Furthermore, connection state management server 500 determines that terminal A is at position “x02:y02” and is connected with receiver B in a period from time 00:04:00 to time 00:05:59. Still further, connection state management server 500 determines that user terminal 110 and TV receiver 210 are not connected in a period from time 00:06:00 to time 00:07:59. Besides, connection state management server 500 determines that terminal A returns to position “x01:y01” again and is connected with receiver A in a period from time 00:08:00 to time 00:10:59.

Thus, the connection state management server according to the present exemplary embodiment can determine a connection state of user terminal 110 and TV receiver 210 by taking into account position information of user terminal 110 based on connection state management table 509 stored in memory 110.

[3-3. Configuration of Relevance Degree Reference Table]

FIG. 16 is a diagram illustrating an example of relevance degree reference table 510 held in the connection state management server according to the third exemplary embodiment. Similar to relevance degree reference table 508 described in the first exemplary embodiment, in relevance degree reference table 510 according to the third exemplary embodiment, a plurality of rules in which reference contents, reference values, and relevance degree points are associated with each other are registered. Further, relevance degree reference table 510 is used when the connection state management unit of the connection state management server calculates the degree of relevance between user terminal 110 and TV receiver 210 similar to relevance degree reference table 508.

In relevance degree reference table 510 illustrated in FIG. 16, rule No. 9 is added in addition to each of rule Nos. 1 to 8 illustrated in FIG. 7 in the first exemplary embodiment. Rule No. 9 newly added to relevance degree reference table 510 is a rule unique in the third exemplary embodiment, and is set to calculate the degree of relevance by using GPS information.

In the example indicated in rule No. 9 in FIG. 16, “a moving distance” is set as reference contents, “10 meters” is set as a reference value, and “+2” is set to a relevance degree point. Hence, the connection state management unit of the connection state management server first refers to connection state management table 509 illustrated in FIG. 15, and calculates a moving distance between current user terminal 110 and past user terminal 110 when calculating the degree of relevance based on rule No. 9. Further, connection state management unit does not add the relevance degree point to the degree of relevance between user terminal 110 and TV receiver 210 when the moving distance exceeds 10 meters, and adds the relevance degree point “+2” to the degree of relevance when the moving distance is 10 meters or less.

This rule No. 9 is set to reflect the following situation in calculation of the degree of relevance. For example, it is assumed that user purchases second TV receiver 210 and disposes second TV receiver 210 in the same room as first TV receiver 210. In such a case, the separated distance between these two TV receivers 210 is relatively short, and the moving distance of user terminal 110 is also relatively short. Further, even when a user changes a connection destination of user terminal 110 from first TV receiver 210 to second TV receiver 210, relevance between second TV receiver 210 and user terminal 110 can be regarded to be high. Meanwhile, when the user moves for a long distance and changes the connection destination of user terminal 110, relevance between change destination TV receiver 210 and user terminal 110 can be regarded to be low.

In the present exemplary embodiment, it is possible to obtain position information of user terminal 110 by using GPS 107, so that the connection state management unit of the connection state management server can reflect this situation in calculation of the degree of relevance.

Thus, in the present exemplary embodiment, the connection state management server may compare past position information with current position information of user terminal 110, calculate a separated distance between a position of current user terminal 110 and a position of past user terminal 110, i.e., a moving distance from past user terminal 110 to current user terminal 110, and calculate the degree of relevance based on the calculated moving distance.

In addition, when connection destination TV receiver 210 of user terminal 110 is changed, calculating the degree of relevance based on this rule No. 9 is desirably performed based on connection state information before the change and connection state information after the change. Further, in a period in which connection destination TV receiver 210 is not changed, desirably, calculating the degree of relevance based on rule No. 9 is not performed.

This is to prevent a relevance degree point from being unnecessarily accumulated in the degree of relevance in a period in which a connection destination of user terminal 110 is not changed (i.e., a period in which user terminal 110 does not move).

In view of the example illustrated in FIG. 15, desirably, the connection state management server calculates the degree of relevance based on rule No. 9 by using, for example, connection state information of time 00:02:00 at which terminal A is connected to receiver A and connection state information of time 00:04:00 at which connection between terminal A and receiver B is started, and does not calculate the degree of relevance based on rule No. 9 in a period in which connection between terminal A and receiver A is maintained (e.g., between time 00:01:00 and time 00:02:00).

In addition, connection state management server may use all or some of rule Nos. 1 to 9 indicated in relevance degree reference table 510 in FIG. 16 when calculating the degree of relevance.

In addition, rules registered in relevance degree reference table 510 are by no means limited to each of rule Nos. 1 to 9 described above. Each numerical value illustrated in FIG. 16 may be optionally changed. Other rules may be registered in relevance degree reference table 510.

[3-4. Operation]

Operations of user terminal 110, TV receiver 210 and connection state management server according to the third exemplary embodiment are substantially the same as the operation of each device described in the first exemplary embodiment and the second exemplary embodiment except that GPS information is included in connection state information to be transmitted to the connection state management server.

That is, GPS information is included in information to be transmitted in step S806 and step S807 illustrated in FIG. 8, in step S1005 and step S1006 illustrated in FIG. 10, in step S1105 illustrated in FIG. 11 and in step S1204 and step S1205 illustrated in FIG. 12. However, the other operations are substantially the same.

[3-5. Effect and Others]

As described above, in the information providing system according to the present exemplary embodiment, user terminal 110 is configured to calculate position information indicating a current position of user terminal 110. The connection state management server includes rules for scoring the degree of relevance between TV receiver 210 and user terminal 110 connected to each other, by using this position information.

Thus, the connection state management server can calculate the degree of relevance based on the rule, such as rule No. 9 illustrated in FIG. 16, which is set in association with position information of user terminal 110.

Also, similar to the first exemplary embodiment, the connection state management server of the information providing system according to the present exemplary embodiment can score the degree of relevance as a relatively large numerical value when relevance between TV receiver 210 and user terminal 110 connected to each other is relatively high, and score the degree of relevance as a relatively small numerical value when the relevance is relatively low.

In addition, the information providing system according to the present exemplary embodiment may cause the connection state management server to provide information of the degree of relevance and, in addition, the position information of user terminal 110 to a request source of the degree of relevance (e.g., advertisement distribution server). In this case, the advertisement distribution server which obtains position information of user terminal 110 can distribute information related, for example, to a surrounding of a current position of user terminal 110 (e.g., information about a restaurant near the current position of user terminal 110), to user terminal 110.

### Other Exemplary Embodiments

The first to third exemplary embodiments have been described above as an exemplary technique disclosed in this application. However, the technique according to the present disclosure is not limited to this, and is also applicable to exemplary embodiments which are changed, replaced added, and omitted. Further, the components described in the first to third exemplary embodiments can also be combined to provide new exemplary embodiments.

Next, other exemplary embodiments will be described below.

In the present exemplary embodiment, an example of a providing destination to which the degree of relevance is provided from a connection state management server is web server 300 (e.g., advertisement distribution server). However, in the present disclosure, the providing destination to which the degree of relevance is provided from the connection state management server is by no means limited to the advertisement distribution server. The connection state management server may provide the degree of relevance to a server computer other than the advertisement distribution server. Alternatively, the connection state management server may provide the degree of relevance to an information processing device other than the server computer.

The present disclosure is applicable to a system which provides an information providing service to user terminals. More specifically, the present disclosure is applicable to an advertisement distribution system and the like.

What is claimed is:

1. An information providing system comprising:
a television receiver connectable to a network;
a user terminal configured to execute a program for connecting with the television receiver, and connectable to the network; and
a connection state management server which obtains connection state information including an identifier of the television receiver and an identifier of the user terminal, through the network from one of the television receiver and the user terminal connected to each other, scores a degree of relevance representing a level of relevance between the television receiver and the user terminal connected to each other, based on the connection state information, and provides the scored degree of relevance in response to a request from an outside.

2. The information providing system according to claim 1, wherein
the connection state management server includes one or more rules for scoring the degree of relevance, and
a reference value to be compared with information obtained from the connection state information, and a relevance degree point to be added to the degree of relevance based on a result of the comparison are registered for each of rules in association with each other.

3. The information providing system according to claim 2, wherein the connection state management server includes the rules for scoring the degree of relevance based on the connection state information and a time at which the connection state information is received.

4. The information providing system according to claim 2, wherein the connection state management server includes the rules for scoring the degree of relevance based on the connection state information and a date on which the connection state information is received.

5. The information providing system according to claim 2, wherein the connection state management server includes the rules for scoring the degree of relevance based on the connection state information and a day on which the connection state information is received.

6. The information providing system according to claim 1, wherein
one of the television receiver and the user terminal connected to each other transmits the connection state information to the connection state management server through the network, and
the connection state management server obtains the connection state information through the network.

7. The information providing system according to claim 6, wherein the connection state information is transmitted at a timing at which the television receiver receives a broadcast wave.

8. The information providing system according to claim 6, wherein the connection state information is transmitted at a timing at which the user terminal executes the program.

9. The information providing system according to claim 2, wherein
the user terminal is configured to calculate position information indicating a current position of the user terminal, and
the connection state management server includes the rules for scoring the degree of relevance by using the position information.

10. The information providing system according to claim 1, further comprising a terminal ID server which generates an identifier of the user terminal and transmits the identifier to the user terminal through the network,
wherein the user terminal obtains the identifier of the user terminal from the terminal ID server through the network.

11. An information providing method for an information providing system which comprises:
a television receiver connectable to a network;
a user terminal configured to execute a program for connecting with the television receiver, and connectable to the network; and
a connection state management server connectable to the network,
the information providing method comprising:
at the connection state management server, obtaining connection state information including an identifier of the television receiver and an identifier of the user terminal from one of the television receiver and the user terminal connected to each other;
at the connection state management server, scoring a degree of relevance representing a level of relevance between the television receiver and the user terminal connected to each other, based on the connection state information; and
at the connection state management server, providing the scored degree of relevance in response to a request from an outside.

12. The information providing method according to claim 11, wherein
the connection state management server scores the degree of relevance based on one or more rules for scoring the degree of relevance and the connection state information, and
a reference value to be compared with information obtained from the connection state information and a relevance degree point to be added to the degree of relevance based on a result of the comparison are registered for each of rules in association with each other.

13. The information providing method according to claim 12, further comprising:
at the user terminal, calculating position information indicating a current position of the user terminal; and
at the connection state management server, obtaining the position information,
wherein the connection state management server scores the degree of relevance based on the position information.
